(19) United States
(12) Patent Application Publication
(10) Pub. No.: US 2012/0163471 A1
(43) Pub. Date: Jun. 28, 2012

(54) VARIABLE LENGTH CODING OF VIDEO BLOCK COEFFICIENTS

(75) Inventors: Marta Karczewicz, San Diego, CA (US); Xianglin Wang, San Diego, CA (US)

(73) Assignee: QUALCOMM INCORPORATED, San Diego, CA (US)

(21) Appl. No.: 13/333,903

(22) Filed: Dec. 21, 2011

Related U.S. Application Data
(60) Provisional application No. 61/427,058, filed on Dec. 23, 2010.
(60) Provisional application No. 61/449,651, filed on Mar. 5, 2011.
(60) Provisional application No. 61/450,081, filed on Mar. 7, 2011.

(51) Int. Cl. H04N 7/26

(52) U.S. Cl. 375/240.23; 375/E07.144

(57) ABSTRACT

This disclosure describes techniques for coding transform coefficients for a block of video data. According to some aspects of this disclosure, an encoder or decoder may map between a code number cn and last_pos and level_ID syntax elements associated with a block of video data based on a scaling factor S. The scaling factor S may be based on a size of the block of video data being coded.

This application claims the benefit of U.S. Provisional Application No. 61/427,058 titled “COEFFICIENT CODING WITH VARIABLE LENGTH CODE IN VIDEO CODING” filed Dec. 23, 2010, U.S. Provisional Application No. 61/449,651 titled “COEFFICIENT CODING WITH VARIABLE LENGTH CODE IN VIDEO CODING” filed Mar. 5, 2011, and U.S. Provisional Application No. 61/450,081 titled “COEFFICIENT CODING WITH VARIABLE LENGTH CODE IN VIDEO CODING” filed Mar. 7, 2011, the entire contents of each of which are incorporated herein by reference.

### TECHNICAL FIELD

This disclosure relates to video coding and compression. More specifically, this disclosure is directed to techniques for entropy coding quantized transform coefficients using variable length coding (VLC).

### BACKGROUND

In video coding, quantized transform coefficients, as well as motion vectors describing relative motion between a block to be encoded and a reference block, may be referred to as “syntax elements.” Syntax elements, along with other control information, may form a coded representation of the video sequence. In some examples, prior to transmission from an encoder to a decoder, syntax elements may be entropy coded, thereby further reducing a number of bits needed for their representation. Entropy coding may be described as a lossless operation aimed at minimizing a number of bits required to represent transmitted or stored symbols (e.g., syntax elements) by utilizing properties of their distribution (e.g., some symbols occur more frequently than others).

One method of entropy coding employed by video coders is Variable Length Coding (VLC). According to VLC, a VLC codeword (a sequence of bits (0's and 1's)), may be assigned to each symbol (e.g., syntax element). VLC code words may be constructed such that a length of the codeword corresponds to how frequently the symbol represented by the codeword occurs. For example, more frequently occurring symbols may be represented by shorter VLC code words. In addition, VLC code words may be constructed such that the code words are uniquely decodable. For example if a decoder receives a valid sequence of bits of a finite length, there may be only one possible sequence of input symbols that, when encoded, would produce the received sequence of bits.

### SUMMARY

This disclosure is directed to techniques and devices that code transform coefficients of a block of video data using variable length coding (VLC). According to one aspect of this disclosure, techniques are described for mapping between a code number cn and a last_pos and a level_ID syntax element associated with a block of video data, based on a scaling factor S. The scaling factor S may correspond to a size of a block of video data being coded. The mapping may comprise a structured mapping, as opposed mapping using a mapping table of a plurality of mapping tables stored in memory.

According to another aspect of this disclosure, techniques are described for mapping between a code number cn and a VLC codeword that represents a last_pos syntax element and a level_ID syntax element based on a VLC table index value adaptively updated based on a scaling factor M. The scaling factor M may correspond to a size of a block of video data being coded.

According to another aspect of this disclosure, techniques are described for mapping between a code number cn and a VLC codeword that represents a run syntax element and a level_ID syntax element associated with a transform coefficient of a block of video data, based on a coded block type of a block of video data being coded. The coded block type may comprise, for example, an inter-luma, inter-chroma, intra-luma, or intra-chroma coded block type.

According to one example, a method for decoding a block of video data is described herein. The method includes determining a code number cn based on a variable length code (VLC) codeword that represents a level_ID syntax element and a last_pos syntax element associated with a block of video data. The method further includes mapping from the determined code number cn to the level_ID syntax element and the last_pos syntax element based on a scaling factor S. The method further includes using the determined level_ID syntax element and the determined run syntax element to decode the block of video data.

According to another example, a device configured to decode at least one block of video data is described herein. The device includes a VLC decoding module. The VLC decoding module is configured to determine a code number cn based on a variable length code (VLC) codeword that represents a level_ID syntax element and a last_pos syntax element associated with a block of video data. The VLC decoding module is further configured to map from the determined code number cn to the level_ID syntax element and the last_pos syntax element based on a scaling factor S. The VLC decoding module is further configured to use the determined level_ID syntax element and the determined run syntax element to decode the block of video data.

According to another example, a computer-readable storage medium is described herein. The computer-readable storage medium stores instructions that cause a computing device to determine a code number cn based on a variable length code (VLC) codeword that represents a level_ID syntax element and a last_pos syntax element associated with a block of video data. The instructions further cause the computing device to map from the determined code number cn to the level_ID syntax element and the last_pos syntax element based on a scaling factor S. The instructions further cause the computing device to use the determined level_ID syntax element and the determined run syntax element to decode the block of video data.

According to another example, a device configured to decode at least one block of video data is described herein. The device includes means for determining a code number cn based on a variable length code (VLC) codeword that represents a level_ID syntax element and a last_pos syntax element associated with a block of video data. The device further includes means for mapping from the determined code number cn to the level_ID syntax element and the last_pos syntax element based on a scaling factor S. The device further includes means for using the determined level_ID syntax element and the determined run syntax element to decode the block of video data.

According to another example, a method for encoding a block of video data is described herein. The method includes determining a level_ID syntax element associated with at least one transform coefficient of a block of video data. The method further includes determining a last_pos syntax element associated with the block of video data. The method further includes mapping from the determined level_ID syntax element and the determined last_pos syntax element to a code number cn based on a scaling factor S. The method further includes determining a variable length code (VLC) codeword based on the determined code number cn. The method further includes outputting the determined VLC codeword.

According to another example, a device configured to encode at least one block of video data is described herein. The device includes a variable length code (VLC) encoding module configured to determine a level_ID syntax element associated with at least one transform coefficient of a block of video data. The VLC encoding module is further configured to determine a last_pos syntax element associated with the block of video data. The VLC encoding module is further configured to map from the determined level_ID syntax element and the determined last_pos syntax element to a code number cn based on a scaling factor S. The VLC encoding module is further configured to determine a VLC codeword based on the determined code number cn. The VLC encoding module is further configured to output the determined VLC codeword.

According to another example, a computer-readable storage medium that stores instructions is described herein. The instructions are configured to, when executed, cause a computing device to determine a level_ID syntax element associated with at least one transform coefficient of a block of video data. The instructions are further configured to cause the computing device to determine a last_pos syntax element associated with the block of video data. The instructions are further configured to map from the determined level_ID syntax element and the determined last_pos syntax element to a code number cn based on a scaling factor S. The instructions are further configured to determine a variable length code (VLC) codeword based on the determined code number cn. The instructions are further configured to output the determined VLC codeword.

According to another example, a device configured to encode at least one block of video data is described herein. The device includes means for determining a level_ID syntax element associated with at least one transform coefficient of a block of video data. The device further includes means for determining a last_pos syntax element associated with the block of video data. The device further includes means for mapping from the determined level_ID syntax element and the determined last_pos syntax element to a code number cn based on a scaling factor S. The device further includes means for determining a variable length code (VLC) codeword based on the determined code number cn. The device further includes means for outputting the determined VLC codeword.

According to one example, a method of coding a block of video data is described herein. The method includes using a variable length code (VLC) table index value to map between a first code number cn and a first VLC codeword associated with at least a first block of video data. The method further includes updating the VLC table index value based on a scaling factor M. The method further includes using the updated VLC table index value to map between a second code number cn and a second VLC codeword associated with a second block of video data.

According to another example, a device configured to code at least one block of video data is described herein. The device includes a variable length code (VLC) coding module. The VLC coding module is configured to use a VLC table index value to map between a first code number cn and a first VLC codeword. The VLC coding module is further configured to update the VLC table index value based on a scaling factor M. The VLC coding module is further configured to use the updated VLC table index value to map between a second code number cn and a second VLC codeword.

According to another example, a computer-readable storage medium that stores instructions is described herein. The instructions, when executed, cause a computing device to use a variable length code (VLC) table index value to map between a first code number cn and a first VLC codeword. The instructions further cause the computing device to update the VLC table index value based on a scaling factor M. The instructions further cause the computing device to use the updated VLC table index value to map between a second code number cn and a second VLC codeword.

According to another example, a device configured to code at least one block of video data is described herein. The device includes means for using a variable length code (VLC) table index value to map between a first code number cn and a first VLC codeword. The device further includes means for updating the VLC table index value based on a scaling factor M. The device further includes means for using the updated VLC table index value to map between a second code number cn and a second VLC codeword.

According to one example, a method of decoding at least one transform coefficient of a block of video data is described herein. The method includes determining a coded block type of a block of video data. The method further includes mapping from a variable length code (VLC) codeword that represents a level_ID syntax element and a run syntax element associated with a transform coefficient of a block of video data to a code number cn based on the determined coded block type of the block of video data. The method further includes determining the level_ID syntax element and the run syntax element based on the determined code number cn. The method further includes using the determined level_ID syntax element and the determined run syntax element to decode the block of video data.

According to another example, a device configured to decode at least one transform coefficient of a block of video data. The device includes a variable length code (VLC) decoding module configured to determine a coded block type of a block of video data. The VLC decoding module is further configured to map from a variable length code (VLC) codeword that represents a level_ID syntax element and a run syntax element associated with a transform coefficient of a block of video data to a code number cn based on the determined coded block type of the block of video data. The VLC decoding module is further configured to determine the level_ID syntax element and the run syntax element based on the determined code number cn. The VLC decoding module is further configured to use the determined level_ID syntax element and the determined run syntax element to decode the block of video data.

According to another example, a computer-readable storage medium is described herein. The computer-readable storage medium stores instructions that, when executed, cause a computing device to determine a coded block type of a block of video data. The instructions further cause the computing device to map from a variable length code (VLC) codeword that represents a level_ID syntax element and a run syntax element associated with a transform coefficient of a block of video data to a code number cn based on the determined coded block type of the block of video data. The instructions further cause the computing device to determine the level_ID syntax element and the run syntax element based on the determined code number cn. The instructions further cause the computing device to use the determined level_ID syntax element and the determined run syntax element to decode the block of video data.

According to another example, a device configured to decode at least one transform coefficient of a block of video data is described herein. The device includes means for determining a coded block type of a block of video data. The device further includes means for mapping from a variable length code (VLC) codeword that represents a level_ID syntax element and a run syntax element associated with a transform coefficient of a block of video data to a code number cn based on the determined coded block type of the block of video data. The device further includes means for determining the level_ID syntax element and the run syntax element based on the determined code number cn. The device further includes means for using the determined level_ID syntax element and the determined run syntax element to decode the block of video data.

According to another example, a method of encoding at least one transform coefficient of a block of video data is described herein. The method includes determining a coded block type of a block of video data. The method further includes determining the level_ID syntax element and the run syntax element associated with a transform coefficient of the block of video data. The method further includes determining a code number cn based on the determined level_ID syntax element and the determined run syntax elements. The method further includes mapping from the determined code number cn to a variable length code (VLC) codeword that represents the level_ID syntax element and the run syntax element based on the determined coded block type of the block of video data. The method further includes outputting the determined VLC codeword.

According to another example, a device configured to encode at least one transform coefficient of a block of video data is described herein. The device includes a variable length code (VLC) encoding module configured to determine a coded block type of a block of video data. The VLC encoding module is further configured to determine the level_ID syntax element and the run syntax element associated with a transform coefficient of the block of video data. The VLC encoding module is further configured to determine a code number cn based on the determined level_ID syntax element and the determined run syntax elements. The VLC encoding module is further configured to map from the determined code number cn to a variable length code (VLC) codeword that represents the level_ID syntax element and the run syntax element based on the determined coded block type of the block of video data. The VLC encoding module is further configured to output the determined VLC codeword.

According to another example, a computer-readable storage medium is described herein. The computer-readable storage medium stores instructions configured to cause a computing device to determine a coded block type of a block of video data. The instructions are further configured to cause the computing device to determine the level_ID syntax element and the run syntax element associated with a transform coefficient of the block of video data. The instructions are further configured to cause the computing device to determine a code number cn based on the determined level_ID syntax element and the determined run syntax elements. The instructions are further configured to cause the computing device to map from the determined code number cn to a variable length code (VLC) codeword that represents the level_ID syntax element and the run syntax element based on the determined coded block type of the block of video data. The instructions are further configured to cause the computing device to output the determined VLC codeword.

According to another example, a device configured to encode at least one transform coefficient of a block of video data is described herein. The device includes means for determining a coded block type of a block of video data. The device further includes means for determining the level_ID syntax element and the run syntax element associated with a transform coefficient of the block of video data. The device further includes means for determining a code number cn based on the determined level_ID syntax element and the determined run syntax elements. The device further includes means for mapping from the determined code number cn to a variable length code (VLC) codeword that represents the level_ID syntax element and the run syntax element based on the determined coded block type of the block of video data. The device further includes means for outputting the determined VLC codeword.

The details of one or more examples are set forth in the accompanying drawings and the description below. Other features, objects, and advantages of the invention will be apparent from the description and drawings, and from the claims.

### BRIEF DESCRIPTION OF DRAWINGS

FIG. 1 is a block diagram that illustrates one example of a video encoding and decoding system consistent with the techniques of this disclosure.

FIG. 2 is a block diagram that illustrates one example of a video encoder consistent with the techniques of this disclosure.

FIG. 3 is a block diagram that illustrates one example of a video decoder consistent with the techniques of this disclosure.

FIG. 4 is a conceptual diagram that illustrates one example of an inverse zig-zag scan of transform coefficients of a block of video data according to one or more aspects of this disclosure.

FIG. 5 is a conceptual diagram that illustrates one example of a mapping technique that may be performed by an encoder according to one or more aspects of this disclosure.

FIG. 6 is a conceptual diagram that illustrates one example of a mapping technique that may be performed by a decoder according to one or more aspects of this disclosure.

FIG. 7 is a flow diagram that illustrates one example of a method of encoding a block of video data consistent with one or more aspects of this disclosure.

FIG. 8 is a flow diagram that illustrates one example of a method of decoding a block of video data consistent with one or more aspects of this disclosure.

FIG. 9 is a conceptual diagram that illustrates another example of a technique for encoding a block of video data consistent with one or more aspects of this disclosure.

FIG. 10 is a conceptual diagram that illustrates another example of a technique for encoding a block of video data consistent with one or more aspects of this disclosure.

FIG. 11 is a flow diagram that illustrates another example of a method of coding a block of video data consistent with one or more aspects of this disclosure.

FIG. 12 is a conceptual diagram that illustrates another example of a technique for encoding a block of video data consistent with one or more aspects of this disclosure.

FIG. 13 is a conceptual diagram that illustrates another example of a technique for encoding a block of video data consistent with one or more aspects of this disclosure.

FIG. 14 is a flow diagram that illustrates one example of a method of encoding a block of video data consistent with one or more aspects of this disclosure.

FIG. 15 is a flow diagram that illustrates one example of a method of decoding a block of video data consistent with one or more aspects of this disclosure.

### DETAILED DESCRIPTION

This disclosure describes video coding techniques for coding (e.g., encoding or decoding) syntax elements (e.g., quantized transform coefficients) of a block of video data using one or more variable length code (VLC) code words of a VLC table. According to these techniques, an encoder may determine at least one value associated with a transform coefficient of a block, map the determined at least one value to a code number cn, and use the code number cn to access a VLC table. Based on the determined code number cn, the encoder may output a VLC code word that represents the at least one determined value associated with the transform coefficient.

VLC code words of a VLC table may be constructed such that a length of the codeword corresponds to how frequently the symbol represented by the codeword occurs. For example, more frequently occurring symbols may be represented by shorter VLC code words. In addition, VLC code words may be constructed such that the code words are uniquely decodable. For example if a decoder receives a valid sequence of bits of a finite length, there may be only one possible sequence of input symbols that, when encoded, would produce the received sequence of bits.

As described herein, an encoder may generate one or more syntax elements as part of an entropy encoded bit stream. The entropy encoded bit stream may signal the one or more syntax elements to a decoder, in some cases via a VLC codeword that represents the one or more syntax elements. In some examples, such an entropy encoded bit stream may be accessible to the decoder from a memory storage component local to the decoder, or available to the decoder via a network. In other examples, such an entropy encoded bit stream may be communicated from the encoder to the decoder, or from another computing device to the decoder.

In some examples, a decoder may determine a VLC codeword that represents one or more syntax elements associated with the transform coefficient based on an entropy encoded bit stream, and use the VLC code word to determine the signaled syntax element in order to decode the transform coefficient. For example, the decoder may access a VLC table (e.g., the same VLC table as used by the encoder as described above), and determine a code number based on the VLC code word. The decoder may map the determined code number cn to at least syntax element associated with the transform coefficient. By using VLC code words to signal, to a decoder, one or more values associated with transform coefficients of a block of video data, an amount of data used to code (e.g., encode or decode) a block of video data may be reduced.

In some examples, coefficients of a given block of a video frame may be ordered (scanned) according to a scanning technique. Such a technique may be used to convert a two-dimensional block of coefficients into a one-dimensional representation of the coefficients, which may be referred to as a one-dimensional coefficient vector of the coefficients. According to one example, coefficients of a block of video data may be scanned according to a zig-zag scanning technique or another pre-defined scanning order. According to a zig-zag scanning technique, a encoder or decoder may begin at an upper leftmost coefficient of a block, and proceeding to scan in a zig-zag pattern to a lower rightmost coefficient of the block.

According to a zigzag scanning technique, it may be presumed that transform coefficients having a greatest energy (e.g., a greatest coefficient value) correspond to low frequency transform functions and may be located towards a top-left of a block. As such, for a coefficient vector (e.g., one-dimensional coefficient vector of the coefficients) produced based on zigzag scanning, higher magnitude coefficients may be assumed to most likely appear towards a start of the one-dimensional coefficient vector. It may also be presumed that, after a coefficient vector has been quantized, most low energy coefficients may be equal to 0. In some examples, coefficient scanning may be adapted during coefficient coding. For example a lower index number in the scan may be assigned to positions for which non-zero coefficients are statistically more probable. Although many of the techniques of this disclosure will be described from the perspective of zig-zag scans (and/or inverse zig-zag scans), other scans (e.g., horizontal scans, vertical scans, combinations of horizontal, vertical and/or zig-zag scans, adaptive scans or other scans) could also be used.

According to one example, an encoder or a decoder may perform an inverse zig-zag scan. According to an inverse zig-zag scan, the encoder or decoder may begin coding at a location that corresponds to a last non-zero coefficient (e.g., a non-zero coefficient furthest from an upper left position of the block). The encoder or decoder may code in a zig-zag pattern as described above, but beginning in a bottom right position of the block and ending in an upper left position of the block.

According to some examples, a encoder or decoder may be configured to operate in multiple different coding modes when performing a scan of transform coefficients. According to one such example, a coder may switch between a run coding mode and a level mode of coding based on magnitudes of one or more already coded coefficients.

According to a level coding mode, an encoder may signal a magnitude (|level|) of each coefficient. For example, the encoder may signal the magnitude (|level|) using a VLC table of a plurality of VLC tables (e.g., a table VLC[x], where x is zero for a first coefficient that is being coded in the level mode). According to a level coding mode, after decoding each coefficient, if |level| of the syntax element has a magnitude greater than a predetermined value (e.g., vlc_level_table[x]), then the value x may be incremented by one.

According to a run coding mode, an encoder may signal (e.g., via an entropy encoded bit stream) a last_pos syntax element associated with a block of video data. The last_pos syntax element may indicate, to a decoder, a position of a last non-zero coefficient in zig-zag scan order (a first non-zero coefficient in inverse zig-zag scan order). The encoder may also signal a level_ID syntax element that indicates a magnitude of a current coefficient. For example, the level_ID syntax element may indicate whether a non-zero coefficient has an amplitude of one or an amplitude greater than one. For a first non-zero coefficient of an inverse zig-zag scan, in some examples, an encoder may signal both a level_ID syntax element that indicates a magnitude of the first non-zero coefficient, as well as a last_pos syntax element that indicates a position of the first non-zero coefficient of the scan.

Also according to a run coding mode, for one or more other coefficients of the block of video, the encoder may signal a level_ID syntax element and/or run syntax element associated with a scanned coefficient, as well as other values. The run syntax element may indicate a number of quantized coefficients with an amplitude of zero between a current (currently coded) coefficient and a next non-zero coefficient in scan order (e.g., an inverse zig-zag scan order). A current coefficient may refer to a first coefficient of a run to a next non-zero coefficient according to a scan order. According to one example, the “run” of zeros defined by the run syntax element may have a value in a range from zero to k+1, wherein k is a position index value of the current coefficient in a scan.

According to a run coding mode, for a block of video data, an encoder may determine values for last_pos and level_ID, and signal the values for last_pos and level_ID as a VLC code word that represents the last_pos and level_ID syntax elements. The decoder may use the received VLC code word to determine values for the last_pos and level_ID syntax elements. The decoder may use the determined last_pos and level_ID values to decode a block of video data. For example, the decoder may use the last_pos syntax element, to determine a first non-zero coefficient position of a scan (e.g., in an inverse zig-zag scan).

According to some video coding techniques, to determine a VLC code word that represents last_pos and level_ID syntax elements as described above, an encoder may access a mapping table of a plurality of mapping tables (e.g., stored in a memory of the encoder) that defines a mapping between the values last_pos and level_ID and a code number cn. According to these techniques, such a mapping table may be selected by an encoder based on a position k of a coefficient in the scan order. For example, a first such mapping table may be used for a position k equal to zero, and a second, different mapping table may be used for a position k equal to one. Position k may be described to as a number of coefficients between a current coefficient and a last coefficient in scan order. Again, although the techniques of this disclosure are described according to zig-zag and inverse zig-zag scans, similar techniques could apply to any scan order, including horizontal scan orders, vertical scan orders, more complex scan orders that change between zig-zag, horizontal and/or vertical, or even adaptive or changing scan orders.

According to some aspects, this disclosure describes techniques for mapping between last_pos and level_ID syntax elements associated with a transform coefficient of video data and a code number cn based on a scaling factor S. The scaling factor S may be determined based on a size (i.e., a number of transform coefficients) of a block of video data that includes the transform coefficients. In some examples, such a mapping based on a scaling factor S may not utilize a mapping table of a plurality of mapping tables stored in memory, as described above with respect to some video coding techniques. Instead, the encoder or decoder may map between the last_pos and level_ID syntax elements and the code number cn using a structured mapping that defines a relationship between the last_pos and level_ID syntax elements and the code number cn. In some examples, these techniques may enable encoder or decoder to perform run mode coding as described above, on blocks of video data with different sizes.

The code number cn may represent an index within a VLC table of a plurality of VLC tables. The encoder or decoder may select a VLC table from among a plurality of VLC tables, and may input a determined code number cn to the selected VLC table in order to determine a VLC code word that represents the last_pos and level_ID syntax elements described above. In some examples, the encoder or decoder may select the VLC table based on a VLC table index value. The VLC table index value may indicate which, of a plurality of VLC tables stored in memory, the encoder or decoder should select to determine a VLC codeword. In some examples, such a VLC table index value may be adaptively updated as blocks of video data are being coded. For example, each time the coder codes last_pos and level_ID values for a of a block of video data, the encoder or decoder may update the VLC table index value, depending on a determined value of one of the last_pos syntax element, the level_ID syntax element and the code number cn.

According to another aspect of this disclosure, techniques are described for adaptively updating a VLC table index value as described above, based on a scaling factor M. The scaling factor M may be determined based on a size (e.g., a number of transform coefficients) of a block of video data being coded. In some examples, these techniques may enable a encoder or decoder to perform run mode coding as described above, on blocks of video data with different sizes.

As described above, according to some examples of a run coding mode, for one or more other coefficients of the block of video (e.g., other than a first coefficient in scan order indicated by the last_pos syntax element), the encoder may signal a level_ID syntax element and/or a run syntax element associated with a scanned coefficient, as well as other values. In some examples, such a level_ID syntax element and/or a run syntax element may be signaled as a VLC codeword.

In some examples, to determine a VLC code word that represents a level_ID syntax element and a run syntax element, an encoder may first map from determined values for the level_ID and run syntax elements to a code number cn based on a mapping table of a plurality of mapping tables stored in memory. According to this example, the encoder may select the mapping table based on a position k of a transform coefficient. In some examples, once the encoder determines a code number cn, the encoder may use the code number cn to access at least one VLC table of a plurality of VLC tables stored in memory. According to some video coding techniques, the encoder may select such a VLC table based on a position k of a transform coefficient. A decoder may use the same or similar VLC tables to decode a block of video data, based on a position k of a transform coefficient.

According to some aspects of this disclosure, techniques are described for determining a VLC codeword that represents level_ID and run syntax elements based on a coded block type of a block of video data. For example, these techniques may include selecting a VLC table of a plurality of VLC tables. According to these techniques, a encoder or decoder may select a first VLC table if a the block of video data has a first coded block type, and select a second VLC table if the block of video data has a second coded block type different than the first. In some examples, these techniques may also include selecting the VLC table of the plurality of VLC tables based on a position k of a transform coefficient of the block of video data, as well as the coded block type of the block of video data. According to other examples, an encoder or decoder may not use a VLC table of a plurality of VLC tables to determine a VLC codeword. According to these examples, the encoder or decoder may determine the VLC codeword based on a mathematical relationship between a code number cn, a coded block type of a block of video data being coded, and the VLC codeword.

The techniques described herein may be performed by an encoder or a decoder. For example according to some aspects of this disclosure, an encoder may use the various techniques described herein, alone or in combination, to determine a VLC code word that represents determined level_ID and last_pos syntax elements associated with a transform coefficient of a block of video data. According to other aspects of this disclosure, the encoder may use the various techniques described herein, alone or in combination, to determine a VLC code word that represents determined level_ID and run syntax elements associated with a transform coefficient of a block of video data. As another example, according to some aspects of this disclosure, a decoder may use the various techniques described herein, alone or in combination, to determine level_ID and last_pos syntax elements associated with the transform coefficient based on a received VLC codeword. According to other aspects of this disclosure, the decoder may use the various techniques described herein, alone or in combination, to determine level_ID and run syntax elements associated with a transform coefficient of a block of video data, based on a received VLC codeword.

In some examples, a video encoder may entropy an array of transform coefficients to compress video data. In some examples, the video encoder may be configured to use variable length codes (VLCs) to represent various possible quantized transform coefficients of the array, e.g., using context-adaptive variable-length coding (CAVLC). In other examples, the video encoder may be configured to use binary arithmetic coding to encode the resulting quantized coefficients, e.g., using context-adaptive binary arithmetic coding (CABAC).

In some examples, a video coder (e.g., encoder, decoder) may be configured to use VLC as a binarization scheme for CABAC to code transform coefficients. For example, a video encoder operating to use CABAC may be configured to use VLC techniques, such as those described herein, to encode the transform coefficients into a stream of binary values. According to these examples, such binary values may then be coded using CABAC. In some examples, using VLC as a binarization scheme for CABAC may generate less binary values (i.e., less bits of data) for a CABAC coder (e.g., encoder, decoder) to code in comparison to other techniques, which may improve the throughput of CABAC coding performed by the coder. In some examples, binarized values generated using VLC as a binarization scheme for CABAC may be coded using a CABAC bypass mode, where each binary value may be assumeded to be equally likely to have a value of 0 or 1. In some examples, coding using such a CABAC bypass mode may be simpler than other standard CABAC coding techniques.

In some examples, a video coder as described herein may be configured to transition between using VLC and using other techniques as the binarization process for CABAC. For example, a video coder may be configured to use VLC to binarize some transform coefficients, and use another technique to perform binarization of other coefficients. In some examples, such a video coder may dynamically determine whether to use VLC as the binarization process of CABAC or some other technique, based on one or more characteristics of video data being coded.

According one or more aspects of this disclosure, techniques are described for coding transform coefficients using VLC. Any of these techniques may be used alone to code one or more transform coefficients of video data, or in combination with one or more other techniques for coding transform coefficients of video data, such as CABAC techniques. For example, any of the VLC coding techniques described herein may be used as a binarization scheme for CABAC to code transform coefficients, as described above.

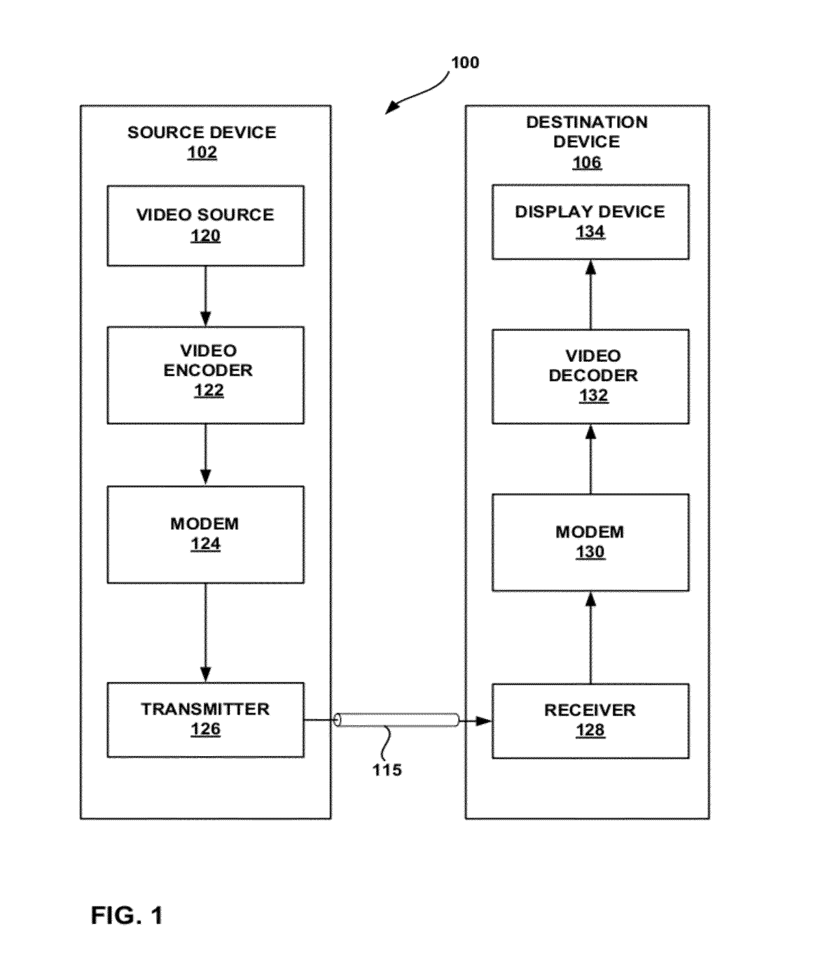

FIG. 1 is a block diagram illustrating an exemplary video encoding and decoding system 100 that may implement techniques of this disclosure. As shown in FIG. 1, system 100 includes a source device 102 that transmits encoded video to a destination device 106 via a communication channel 115. Source device 102 and destination device 106 may comprise any of a wide range of devices. In some cases, source device 102 and destination device 106 may comprise wireless communication device handsets, such as so-called cellular or satellite radiotelephones. The techniques of this disclosure, however, which apply generally to the encoding and decoding transform coefficients of video data, are not necessarily limited to wireless applications or settings, and may be applied to a wide variety of non-wireless devices that include video encoding and/or decoding capabilities.

In the example of FIG. 1, source device 102 may include a video source 120, a video encoder 122, a modulator/demodulator (modem) 124 and a transmitter 126. Destination device 106 may include a receiver 128, a modem 130, a video decoder 132, and a display device 134. In accordance with this disclosure, video encoder 122 of source device 102 may be configured to encode at least one syntax element associated with a transform coefficient (e.g., last_pos, level_ID, and/or run syntax elements) based on determining a code number cn. For example, video encoder 122 may use the determined code number cn to determine a VLC code word that represents the at least one syntax element.

According to one aspect of this disclosure, video encoder 122 may map from determined last_pos and level_ID syntax elements to a code number cn, based on a scaling factor S. Video encoder 122 may determine the scaling factor S based on a size (i.e., a number of transform coefficients) of a block of video data that includes the transform coefficients. For example, video encoder 122 may determine values of last_pos and level_ID syntax elements associated with a first non-zero transform coefficient of a block of video data (e.g., a first non-zero transform coefficient of an inverse zig-zag scan), and determine a code number cn using the values of the last_pos and level_ID syntax elements based on the scaling factor S.

In some examples, to perform such a mapping based on a scaling factor S, video encoder 122 may not utilize a mapping table of a plurality of mapping tables stored in memory, as described above with respect to some video coding techniques. Instead, the video encoder 122 may map between the last_pos and level_ID syntax elements and the code number cn using a structured mapping that defines a relationship between the last_pos and level_ID syntax elements and the code number cn. By using the structured mapping, the need to store mapping tables may be reduced or eliminated.

As described above, the code number cn may represent an index within a VLC table of a plurality of VLC tables. Video encoder 122 may select a VLC table from among a plurality of VLC tables, and may input a determined code number cn to the selected VLC table to determine a VLC code word that represents the last_pos and level_ID syntax elements described above. According to other aspects of this disclosure, video encoder 122 may select the VLC table based on a VLC table index value that is adaptively updated, based on a scaling factor M. For example, according to these aspects of this disclosure, video encoder 122 may, for each block of video data encoded by encoder 122, update the VLC table index based on the scaling factor M. Video encoder 122 may determine scaling factor M based on a size (e.g., a number of transform coefficients) of a block of video data being encoded.

As described above, according to some examples of a run coding mode, for one or more other coefficients of the block of video (e.g., other than a first coefficient in scan order indicated by the last_pos syntax element), video encoder 122 may signal a level_ID syntax element and/or a run syntax element associated with a scanned coefficient, as well as other values. In some examples, such a level_ID syntax element and/or a run syntax element may be signaled as a VLC codeword.

According to other aspects of this disclosure, video encoder 122 may determine a VLC codeword that represents level_ID and run syntax elements based on a coded block type of a block of video data. According to some such examples, video encoder 122 may select a VLC table of a plurality of VLC tables to determine the VLC codeword. For example, according to these techniques, video encoder 122 may select a first VLC table if a the block of video data has a first coded block type, and select a second VLC table if the block of video data has a second coded block type different than the first. In some examples according to these techniques, video encoder 122 may select the VLC table of the plurality of VLC tables based on a position k of a transform coefficient of the block of video data, as well as the coded block type of the block of video data. According to other examples, coder 122 may not use a VLC table of a plurality of VLC tables to determine a VLC codeword. According to these examples, coder 122 may determine the VLC codeword based on a mathematical relationship between a code number cn, a coded block type of a block of video data being coded, and the VLC codeword.

Blocks of video data generally comprise residual blocks of transform coefficients. The transform coefficients may be produced by transforming residual pixel values indicative of differences between a predictive block and the original block being coded. The transform may be an integer transform, a DCT transform, a DCT-like transform that is conceptually similar to DCT, or the like. Transforms may be implemented according to a so-called butterfly structure for transforms, or may be implemented as matrix multiplications. The transform coefficients may be quantized in some examples in order to reduce the bit depths of the transform coefficients.

Reciprocal transform coefficient decoding may also be performed by video decoder 132 of destination device 106. That is, according to one aspect of this disclosure, video decoder 132 may receive a VLC code word associated with a transform coefficient, determine a code number cn, and determine values associated with last_pos and level_ID syntax elements for a block of video data that includes the transform coefficient based on a scaling factor S. Video decoder 132 may determine the scaling factor S based on a size (i.e., a number of transform coefficients) of a block of video data that includes the transform coefficients. For example, video decoder 132 may determine a code number cn based on a received VLC code word, and determine values of last_pos and level_ID syntax elements associated with a first non-zero transform coefficient of a block of video data (e.g., a first non-zero transform coefficient of an inverse zig-zag scan) based on the scaling factor S.

In some examples, to perform such a mapping based on a scaling factor S, video decoder 132 may not utilize a mapping table of a plurality of mapping tables stored in memory, as described above with respect to some video coding techniques. Instead, video decoder 132 may map from the code number cn to the last_pos and level_ID syntax using a structured mapping that defines a relationship between the last_pos and level_ID syntax elements and the code number cn.

The code number cn may represent an index within a VLC table of a plurality of VLC tables. Video decoder 132 may select a VLC table from among a plurality of VLC tables, and decode a VLC codeword from a bitstream using the selected VLC table to determine a code number that represents last_pos and level_ID syntax elements described above. According to some aspects of this disclosure, video decoder 132 may select the VLC table based on a VLC table index value that is adaptively updated, based on a scaling factor M. For example, according to these aspects of this disclosure, video decoder 132 may, for each block of video data decoded by video decoder 132, update the VLC table index based on the scaling factor M. Video decoder 132 may determine scaling factor M based on a size (e.g., a number of transform coefficients) of a block of video data being decoded.

Video decoder 132 may use the various techniques described herein, alone or in combination, to map from a determined code number cn to the level_ID and last_pos syntax elements to determine values of the level_ID and last_pos syntax elements. Video decoder 132 may use determined values of the level_ID and last_pos syntax elements to decode the block of video data.

As described above, according to some examples of a run coding mode, for one or more other coefficients of the block of video (e.g., other than a first coefficient in scan order indicated by the last_pos syntax element), video decoder 132 may be configured to determine a level_ID syntax element and/or a run syntax element associated with a scanned coefficient, as well as other values. In some examples, such a level_ID syntax element and/or a run syntax element may be signaled to video decoder 132 (e.g., by a video encoder 122) as a VLC codeword.

According to still other aspects of this disclosure, video decoder 132 may determine a code number cn that represents level_ID and run syntax elements, based on a coded block type of a block of video data. For example, video decoder 132 may select a VLC table of a plurality of VLC tables to determine the code number cn. For example, according to these techniques, video decoder 132 may select a first VLC table if a the block of video data has a first coded block type, and select a second VLC table if the block of video data has a second coded block type different than the first. In some examples according to these techniques, video decoder 132 may select the VLC table of the plurality of VLC tables based on a position k of a transform coefficient of the block of video data, as well as the coded block type of the block of video data. According to other examples, decoder 132 may not use a VLC table of a plurality of VLC tables to determine a VLC codeword. According to these examples, decoder 132 may determine the VLC codeword based on a mathematical relationship between a VLC codeword and the code number cn and a coded block type of a block of video data being coded.

Video decoder 132 may use the various techniques described herein, alone or in combination, to map from a determined code number cn to the level_ID and run syntax elements to determine values of the level_ID and run syntax elements. Video decoder 132 may use determined values of the level_ID and run syntax elements to decode the block of video data.

The illustrated system 100 of FIG. 1 is merely exemplary. The transform coefficient encoding and decoding techniques of this disclosure may be performed by any encoding or decoding devices. Source device 102 and destination device 106 are merely examples of coding devices that can support such techniques.

Video encoder 122 of source device 102 may encode video data received from video source 120. Video source 120 may comprise a video capture device, such as a video camera, a video archive containing previously captured video, or a video feed from a video content provider. As a further alternative, video source 120 may generate computer graphics-based data as the source video, or a combination of live video, archived video, and computer-generated video. In some cases, if video source 120 is a video camera, source device 102 and destination device 106 may form so-called camera phones or video phones. In each case, the captured, pre-captured or computer-generated video may be encoded by video encoder 122.

In system 100, once the video data is encoded by video encoder 122, the encoded video information may then be modulated by modem 124 according to a communication standard, e.g., such as code division multiple access (CDMA) or any other communication standard or technique, and transmitted to destination device 106 via transmitter 126. Modem 124 may include various mixers, filters, amplifiers or other components designed for signal modulation. Transmitter 126 may include circuits designed for transmitting data, including amplifiers, filters, and one or more antennas. Receiver 128 of destination device 106 receives information over channel 115, and modem 130 demodulates the information. Again, the video decoding process performed by video decoder 132 may include similar (e.g., reciprocal) decoding techniques to the encoding techniques performed by video encoder 122. In other systems, however, there may not be any communication between the encoding and decoding devices. Rather the encoding device may output encoded video to storage, and the decoding device may receive encoded video from any of a variety of sources.

In the example of FIG. 1, communication channel 115 may comprise any wireless or wired communication medium, such as a radio frequency (RF) spectrum or one or more physical transmission lines, or any combination of wireless and wired media. Communication channel 115 may form part of a packet-based network, such as a local area network, a wide-area network, or a global network such as the Internet. Communication channel 115 generally represents any suitable communication medium, or a collection of different communication media, for transmitting video data from source device 102 to destination device 106.

Although not shown in FIG. 1, in some aspects, video encoder 122 and video decoder 132 may each be integrated with an audio encoder and decoder, and may include appropriate MUX-DEMUX units, or other hardware and software, to handle encoding of both audio and video in a common data stream or separate data streams. If applicable, MUX-DEMUX units may conform to the ITU H.223 multiplexer protocol, or other protocols such as the user datagram protocol (UDP).

Video encoder 122 and video decoder 132 each may be implemented as one or more microprocessors, digital signal processors (DSPs), application specific integrated circuits (ASICs), field programmable gate arrays (FPGAs), discrete logic, software, hardware, firmware or any combinations thereof. Each of video encoder 122 and video decoder 132 may be included in one or more encoders or decoders, either of which may be integrated as part of a combined encoder/decoder (CODEC) in a respective mobile device, subscriber device, broadcast device, server, or the like.

In some cases, devices 102, 106 may operate in a substantially symmetrical manner. For example, each of devices 102, 106 may include video encoding and decoding components. Hence, system 100 may support one-way or two-way video transmission between video devices 102, 106, e.g., for video streaming, video playback, video broadcasting, or video telephony.

During the encoding process, video encoder 122 may execute a number of coding techniques or operations. In general, video encoder 122 operates on video blocks within individual video frames (or other independently coded units such as slices) in order to encode the video blocks. Frames, slices, portions of frames, groups of pictures, or other data structures may be defined as independent data units that include a plurality of video blocks, and syntax elements may be included at such different independent data units. The video blocks within independent data units may have fixed or varying sizes, and may differ in size according to a specified coding standard. In some cases, each video frame may include a series of independently decodable slices, and each slice may include one or more macroblocks or LCUs.

Macroblocks are one type of video block defined by the ITU H.264 standard and other standards. Macroblocks typically refer to 16 by 16 blocks of data. The ITU-T H.264 standard supports intra prediction in various block sizes, such as 16 by 16, 8 by 8, or 4 by 4 for luma components, and 8 by 8 for chroma components, as well as inter prediction in various block sizes, such as 16 by 16, 16 by 8, 8 by 16, 8 by 8, 8 by 4, 4 by 8 and 4 by 4 for luma components and corresponding scaled sizes for chroma components.

The emerging HEVC standard defines new terms for video blocks. In particular, with HEVC, video blocks (or partitions thereof) may be referred to as “coded units.” With the HEVC standard, largest coded units (LCUs) may be divided into smaller and smaller coded units (CUs) according to a quadtree partitioning scheme, and the different CUs that are defined in the scheme may be further partitioned into so-called prediction units (PUs) and/or transform units (TUs). The LCUs, CUs, and PUs, and TUs are all video blocks within the meaning of this disclosure. Other types of video blocks may also be used, consistent with the HEVC standard or other video coding standards. Thus, the phrase “block” refers to any size of video block. Moreover, video blocks may sometimes refer to blocks of video data in the pixel domain, or blocks of data in a transform domain such as a discrete cosine transform (DCT) domain, a domain similar to DCT, a wavelet domain, or the like.

Referring again to FIG. 1, video encoder 122 may perform predictive coding in which a video block being coded is compared to another block of video data in order to identify a predictive block. This process of predictive coding across frames is often referred to as motion estimation and motion compensation. Motion estimation estimates video block motion relative to one or more predictive video blocks of one or more predictive frames (or other coded units). Motion compensation generates the desired predictive video block from the one or more predictive frames or other coded units. Motion compensation may include an interpolation process in which interpolation filtering is performed to generate predictive data at fractional pixel precision. This process of prediction coding can also be performed within a frame, where spatially neighboring pixels within the same frame to a current block are used to generate a predictive block.

After generating the predictive block, the differences between the current video block being coded and the predictive block are coded as a residual block, and prediction syntax (such as a motion vector) is used to identify the predictive block. The residual block may be transformed and quantized. Transform techniques may comprise a DCT process or conceptually similar process, integer transforms, wavelet transforms, or other types of transforms. In a DCT or DCT-like process, as an example, the transform process converts a set of pixel values (e.g., residual values) into transform coefficients, which may represent the energy of the pixel values in the frequency domain. Quantization is typically applied on the transform coefficients, and generally involves a process that limits the number of bits associated with any given transform coefficient.

Following transform and quantization, entropy coding may be performed on the transformed and quantized residual video blocks. Syntax elements, (e.g., the last_pos, run and level_ID values described herein), various filter syntax information, and prediction vectors defined during the encoding may be included in the entropy-coded bitstream. In general, entropy coding comprises one or more processes that collectively compress a sequence of quantized transform coefficients and/or other syntax information. Scanning techniques, such as zig-zag scanning (and/or inverse zig-zag scanning) techniques, are performed on the quantized transform coefficients in order to define one or more serialized one-dimensional vectors of coefficients from two-dimensional video blocks. Again, other scan orders, including fixed or adaptive scan orders, could also be used consistent with this disclosure. The scanned coefficients are then entropy coded along with any syntax information in a manner as described herein, to generate an encoded bit stream, which may be used by a decoder to decode the video blocks.

Various techniques for signaling, by an encoded bit stream, one or more syntax elements (e.g., last_pos, level_ID, and/or run syntax elements) to a decoder 132, that may be used by the decoder to decode encoded video data. According to the techniques, the phrase “signaled” may refer to data of an entropy encoded bit stream, which may or may not be “sent” to decoder 132 by encoder 122. For example, encoder 122 may include one or more syntax elements as described herein stored with other data on a computer-readable storage medium. Decoder 132 may receive one or more syntax elements by accessing such a computer readable storage medium, whether or not local to decoder 132. In other example, encoder 122 may also, or instead, be configured to transmit such one or more syntax elements, and/or other information of an entropy encoded bitstream to decoder 132.

As part of the encoding process, encoded video blocks may be decoded to generate the video data used for subsequent prediction-based coding of subsequent video blocks. At this stage, filtering may be employed in order to improve video quality, and e.g., remove blockiness or other artifacts from decoded video. This filtering may be in-loop or post-loop. With in-loop filtering, the filtering of reconstructed video data occurs in the coding loop, which means that the filtered data is stored by an encoder or a decoder for subsequent use in the prediction of subsequent image data. In contrast, with post-loop filtering, the filtering of reconstructed video data occurs out of the coding loop, which means that unfiltered versions of the data are stored by an encoder or a decoder for subsequent use in the prediction of subsequent image data.

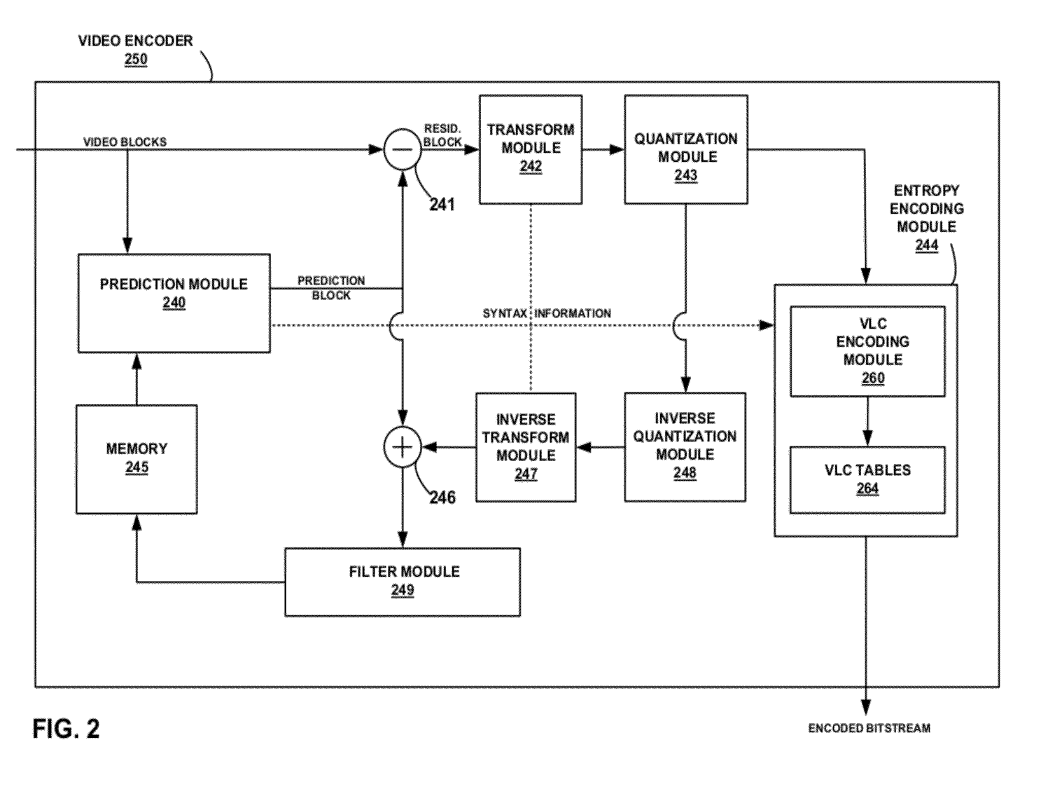

FIG. 2 is a block diagram illustrating an example video encoder 250 consistent with this disclosure. Video encoder 250 may correspond to video encoder 122 of source device 100, or a video encoder of a different device. As shown in FIG. 2, video encoder 250 includes a prediction module 240, adders 241 and 246, and a memory 245. Video encoder 250 also includes a transform module 242 and a quantization module 243, as well as an inverse quantization module 248 and an inverse transform module 247. Video encoder 250 also includes an entropy coding module 244. Entropy coding module 244 includes a VLC encoding module 260.

According to one aspect of this disclosure, VLC encoding module 260 may map from determined last_pos and level_ID syntax elements to a code number cn, based on based on a scaling factor S. VLC encoding module 260 may determine the scaling factor S based on a size (i.e., a number of transform coefficients) of a block of video data that includes the transform coefficients. For example, VLC encoding module 260 may determine values of last_pos and level_ID syntax elements associated with a first non-zero transform coefficient of a block of video data (e.g., a first non-zero transform coefficient of an inverse zig-zag scan), and determine a code number cn using the values of the last_pos and level_ID syntax elements based on the scaling factor S.

In some examples, to perform such a mapping based on a scaling factor S, VLC encoding module 260 may not utilize a mapping table of a plurality of mapping tables stored in memory, as described above with respect to some video coding techniques. Instead, the video encoder 122 may map from the last_pos and level_ID syntax elements to the code number cn using a structured mapping that defines a relationship between the last_pos and level_ID syntax elements and the code number cn.

As described above, the code number cn may represent an index within a VLC table of a plurality of VLC tables. VLC encoding module 260 may select a VLC table from among a plurality of VLC tables 262, and input a determined code number cn to the selected VLC table to determine a VLC code word that represents the last_pos and level_ID syntax elements described above. According to some aspects of this disclosure, VLC encoding module 260 may select the VLC table based on a VLC table index value that is adaptively updated, based on a scaling factor M. For example, according to these aspects of this disclosure, VLC encoding module 260 may, for each block of video data encoded by VLC encoding module 260, update the VLC table index based on the scaling factor M. VLC encoding module 260 may determine scaling factor M based on a size (e.g., a number of transform coefficients) of a block of video data being encoded.

As described above, according to some examples of a run coding mode, for one or more other coefficients of the block of video (e.g., other than a first coefficient in scan order indicated by the last_pos syntax element), video encoder 250 may signal a level_ID syntax element and/or a run syntax element associated with a scanned coefficient, as well as other values. In some examples, such a level_ID syntax element and/or a run syntax element may be signaled as a VLC codeword.

According to other aspects of this disclosure, VLC encoding module 260 may determine a VLC codeword that represents level_ID and run syntax elements, based on a coded block type of a block of video data. According to some examples, VLC encoding module 260 may determine the VLC codeword based on selecting a VLC table of a plurality of VLC tables 262. For example, according to these techniques, VLC encoding module 260 may select a first VLC table if a the block of video data has a first coded block type, and select a second VLC table if the block of video data has a second coded block type different than the first. In some examples according to these techniques, VLC encoding module 260 may select the VLC table of the plurality of VLC tables 262 based on a position k of a transform coefficient of the block of video data, as well as the coded block type of the block of video data. According to other examples, VLC encoding module 260 may not determine the VLC codeword based on selecting a VLC table as described above. Instead, VLC encoding module 260 may determine the VLC codeword based on a mathematical relationship that takes into account the coded block type of the block of video data being encoded.

VLC tables 264 are illustrated as part of entropy coding module 244 insofar as VLC encoding module 260 applies the respective tables. The VLC tables 264, however, may actually be stored in a memory location, such as memory 245, which may be accessible by VLC encoding module 260 to use the respective tables.

During the encoding process, video encoder 250 receives a video block to be coded, and prediction module 240 performs predictive coding techniques. For inter coding, prediction module 240 compares the video block to be encoded to various blocks in one or more video reference frames or slices in order to define a predictive block. For intra coding, prediction module 240 generates a predictive block based on neighboring data within the same frame, slice, or other unit of video data. Prediction module 240 outputs the prediction block and adder 241 subtracts the prediction block from the video block being coded in order to generate a residual block.

For inter coding, prediction module 240 may comprise motion estimation and motion compensation modules (not depicted in FIG. 2) that identify a motion vector that points to a prediction block and generates the prediction block based on the motion vector. Typically, motion estimation is considered the process of generating the motion vector, which estimates motion. For example, the motion vector may indicate the displacement of a predictive block within a predictive frame relative to the current block being coded within the current frame. Motion compensation is typically considered the process of fetching or generating the predictive block based on the motion vector determined by motion estimation. For intra coding, prediction module 240 generates a predictive block based on neighboring data within the same frame, slice, or other unit of video data. One or more intra-prediction modes may define how an intra prediction block can be defined.

Motion compensation for inter-coding may include interpolations to sub-pixel resolution. Interpolated predictive data generated by prediction module 240, for example, may be interpolated to half-pixel resolution, quarter-pixel resolution, or even finer resolution. This permits motion estimation to estimate motion of video blocks to such sub-pixel resolution.

After prediction module 240 outputs the prediction block, and after adder 241 subtracts the prediction block from the video block being coded in order to generate a residual block, transform module 242 applies a transform to the residual block. The transform may comprise a discrete cosine transform (DCT), an integer transform, or a conceptually similar transform such as that defined by the ITU H.264 standard, the HVEC standard, or the like. In some examples, transform module 242 may perform differently sized transforms and may select different sizes of transforms for coding efficiency and improved compression. Wavelet transforms, integer transforms, sub-band transforms or other types of transforms may also be used. In any case, transform module 242 applies a particular transform to the residual block of residual pixel values, producing a block of residual transform coefficients. The transform may convert the residual pixel value information from a pixel domain to a frequency domain.

Inverse quantization module 248 and inverse transform module 247 apply inverse quantization and inverse transform, respectively, to reconstruct the residual block in the pixel domain. Summer 246 adds the reconstructed residual block to the prediction block produced by prediction module 240 to produce a reconstructed video block for storage in memory 245. Filter module 249 may perform in-loop or post loop filtering on reconstructed video blocks.

Memory 245 may store a frame or slice of blocks for use in motion estimation with respect to blocks of other frames to be encoded. Prior to such storage, in the case of in-loop filtering, filter module 249 may apply filtering to the video block to improve video quality. Such filtering by filter module 249 may reduce blockiness or other artifacts. Moreover, filtering may improve compression by generating predictive video blocks that comprise close matches to video blocks being coded. Filtering may also be performed post-loop such that the filtered data is output as decoded data, but unfiltered data is used by prediction module 240.

Quantization module 243 quantizes the residual transform coefficients (e.g., from transform module 242) to further reduce bit rate. Quantization module 243, for example, may limit the number of bits used to code each of the coefficients. After quantization, entropy encoding module 244 may scan and entropy encode the data. For example, entropy encoding module 244 may scan the quantized coefficient block from a two-dimensional representation to one or more serialized one-dimensional vectors. The scan order may be pre-programmed to occur in a defined order (such as zig-zag scanning, inverse zig-zag scanning, horizontal scan, vertical scan, or another pre-defined order), or possibly adaptively defined based on previous coding statistics. Following this scanning process, entropy encoding module 244 encodes the quantized transform coefficients (along with any syntax elements) according to an entropy coding methodology as described herein to further compress the data. Syntax information included in the entropy coded bitstream may include prediction syntax from prediction module 240, such as motion vectors for inter coding or prediction modes for intra coding. Syntax information included in the entropy coded bitstream may also include filter information, such as that applied for interpolations by prediction module 240 or filters applied by filter module 249. In addition, syntax information included in the entropy coded bitstream may also include one or more VLC code words that represent one or more of last_pos, level_ID, and run syntax elements (or other syntax elements) associated with transform coefficients of a block of video data.

The techniques of this disclosure may be considered a type of CAVLC technique. CAVLC techniques use VLC tables in a manner that effectively compresses serialized “runs” of transform coefficients and/or other syntax elements. Similar techniques might also be applied in other types of entropy coding such as context adaptive binary arithmetic coding (CABAC).

In some examples, a video coder (e.g., encoder, decoder) may be configured to use VLC as a binarization scheme for CABAC to code transform coefficients. For example, a video encoder operating to use CABAC may be configured to use VLC techniques, such as those described herein, to encode the transform coefficients into a stream of binary values. According to these examples, such binary values may then be coded using CABAC. In some examples, using VLC as a binarization scheme for CABAC may generate less binary values (i.e., less bits of data) for a CABAC coder (e.g., encoder, decoder) to code in comparison to other techniques, which may improve the throughput of CABAC coding performed by the coder. In some examples, binarized values generated using VLC as a binarization scheme for CABAC may be coded using a CABAC bypass mode, where each binary value may be assumeded to be equally likely to have a value of 0 or 1. In some examples, coding using such a CABAC bypass mode may be simpler than other standard CABAC coding techniques.

In some examples, a video coder as described herein may be configured to transition between using VLC and using other techniques as the binarization process for CABAC. For example, a video coder may be configured to use VLC to binarize some transform coefficients, and use another technique to perform binarization of other coefficients. In some examples, such a video coder may dynamically determine whether to use VLC as the binarization process of CABAC or some other technique, based on one or more characteristics of video data being coded.

According one or more aspects of this disclosure, techniques are described for coding transform coefficients using VLC. Any of these techniques may be used alone to code one or more transform coefficients of video data, or in combination with one or more other techniques for coding transform coefficients of video data, such as CABAC techniques. For example, any of the VLC coding techniques described herein may be used as a binarization scheme for CABAC to code transform coefficients, as described above.

Following the entropy coding by entropy encoding module 244, the encoded video may be transmitted to another device or archived for later transmission or retrieval. Again, the encoded video may comprise the entropy coded vectors and various syntax, which can be used by a decoder to properly configure the decoding process. For example, a decoder may use one or more VLC code words that represent one or more syntax elements associated with an encoded block of video data, and use the VLC code word to decode the encoded block of video data.

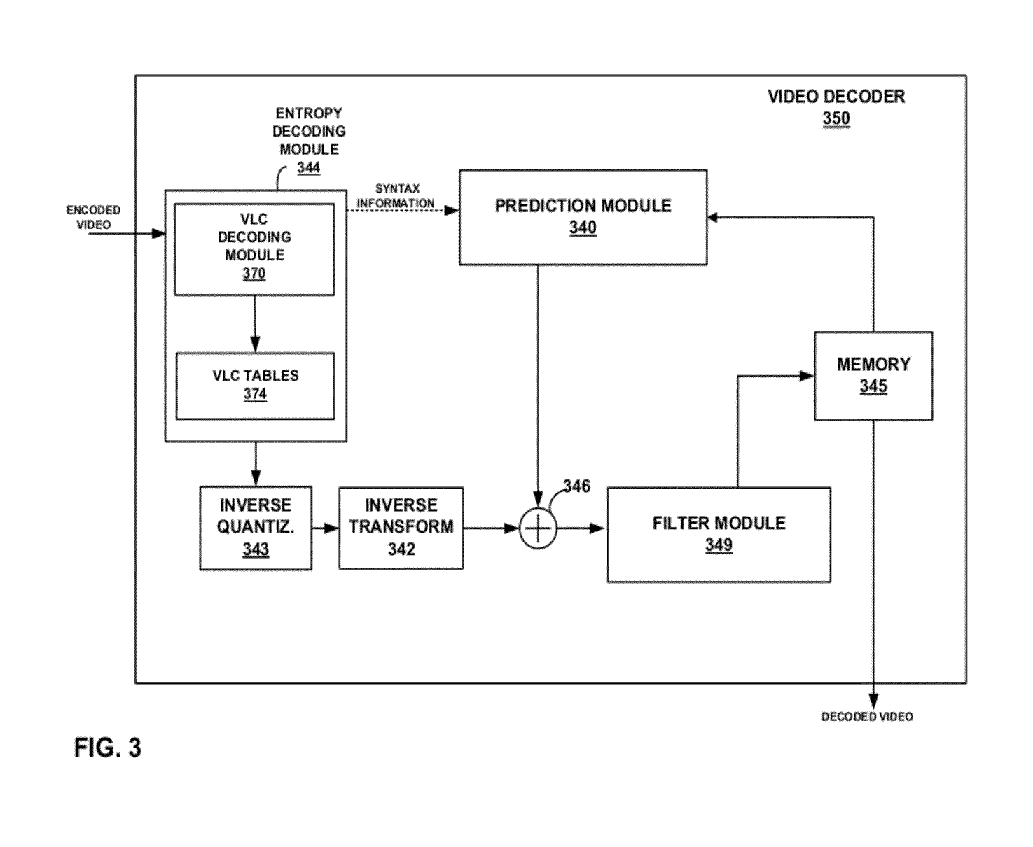

FIG. 3 is a block diagram illustrating an example of a video decoder 350, which decodes a video sequence that is encoded in the manner described herein. The received video sequence may comprise an encoded set of image frames, a set of frame slices, a commonly coded group of pictures (GOPs), or a wide variety of coded video units that include encoded video blocks and syntax information to define how to decode such video blocks.

Video decoder 350 includes an entropy decoding module 344, which performs the reciprocal decoding function of the encoding performed by entropy encoding module 244 of FIG. 2. In particular, entropy decoding module 344 may perform CAVLC techniques as described herein as reciprocal entropy coding to that applied by entropy encoding module 244 of FIG. 2. In this manner, entropy decoding module 344 may convert entropy decoded video blocks in a one-dimensional serialized format from one or more one-dimensional vectors of coefficients back into a two-dimensional block format. The number and size of the vectors, as well as the scan order defined for the video blocks may define how the two-dimensional block is reconstructed. Entropy decoded prediction syntax may be sent from entropy decoding module 344 to prediction module 340.

As also depicted in FIG. 3, entropy decoding module 344 includes a VLC decoding module 370. According to one aspect of this disclosure, VLC decoding module 370 may receive a VLC code word associated with a transform coefficient, determine a code number cn, and determine values associated with last_pos and level_ID syntax elements for a block of video data that includes the transform coefficient based on a scaling factor S. For example, VLC decoding module 370 may determine the scaling factor S based on a size (i.e., a number of transform coefficients) of a block of video data that includes the transform coefficients. For example, VLC decoding module 370 may determine a code number cn based on a received VLC code word, and determine values of last_pos and level_ID syntax elements associated with a first non-zero transform coefficient of a block of video data (e.g., a first non-zero transform coefficient of an inverse zig-zag scan) based on the scaling factor S.

In some examples, to perform such a mapping based on a scaling factor S, VLC decoding module 370 may not utilize a mapping table of a plurality of mapping tables stored in memory, as described above with respect to some video coding techniques. Instead, the VLC decoding module 370 may map from the code number cn to the last_pos and level_ID syntax using a structured mapping that defines a relationship between the last_pos and level_ID syntax elements and the code number cn.

As described above, the code number cn may represent an index within a VLC table of a plurality of VLC tables 374. The plurality of VLC tables 374 may be stored a memory associated with video decoder 350, such as memory 345 depicted in FIG. 3. Video decoder 132 may select a VLC table from among the plurality of VLC tables 372, and decode a VLC codeword from a bitstream using the selected VLC table to determine a code number that represents last_pos and level_ID syntax elements described above.

According to some aspects of this disclosure, VLC decoding module 370 may select the VLC table based on a VLC table index value that is adaptively updated, based on a scaling factor M. For example, according to these aspects of this disclosure, VLC decoding module 370 may, for each block of video data decoded by VLC decoding module 370, update the VLC table index based on the scaling factor M. VLC decoding module 370 may determine the scaling factor M based on a size (e.g., a number of transform coefficients) of a block of video data being decoded.

As described above, according to some examples of a run coding mode, for one or more other coefficients of the block of video (e.g., other than a first coefficient in scan order indicated by the last_pos syntax element), VLC decoding module 370 may be configured to determine a level_ID syntax element and/or a run syntax element associated with a scanned coefficient, as well as other values. In some examples, such a level_ID syntax element and/or a run syntax element may be signaled to VLC decoding module 370 (e.g., by a video encoder 250 depicted in FIG. 2) as a VLC codeword.

According to still other aspects of this disclosure, VLC decoding module 370 may determine a code number cn that represents level_ID and run syntax elements, based on a coded block type of a block of video data being decoded. According to some examples, VLC decoding module 370 may select a VLC table of a plurality of VLC tables 374 to determine the code number cn. For example, according to these techniques, VLC decoding module 370 may select a first VLC table if a the block of video data has a first coded block type, and select a second VLC table if the block of video data has a second coded block type different than the first. In some examples according to these techniques, VLC decoding module 370 may select the VLC table of the plurality of VLC tables 374 based on a position k of a transform coefficient of the block of video data, as well as the coded block type of the block of video data. According to other examples, VLC decoding module 370 may not determine the code number cn by using a VLC table of a plurality of VLC tables. Instead, VLC decoding module 370 may determine the code number cn based on a mathematical relationship that takes into account the coded block type of the block of video data being decoded.

As described above, VLC decoding module 370 may access VLC tables 374 to map a VLC codeword and/or a code number cn to at least one syntax element (e.g., one or more of last_pos, level_ID, and/or run syntax elements). VLC tables 374 are illustrated as part of entropy decoding module 344 insofar as VLC decoding module 370 applies the respective tables. The VLC tables 374, however, may actually be stored in a memory location, such as memory 345, which may be accessible by VLC decoding module 370 to use the tables.

As depicted in FIG. 3, video decoder includes a filter module 349. Filter module 349 may perform in-loop or post loop filtering on reconstructed video blocks. Video decoder 350 also includes a prediction module 340, an inverse quantization unit 343, an inverse transform module 342, a memory 345, and a summer 346.

A wide variety of video compression technologies and standards perform spatial and temporal prediction to reduce or remove the redundancy inherent in input video signals. As explained above, an input video block is predicted using spatial prediction (i.e., intra prediction) and/or temporal prediction (i.e., inter prediction or motion estimation). The prediction modules described herein may include a mode decision module (not shown) in order to choose a desirable prediction mode for a given input video block. Mode selection may consider a variety of factors such as whether the block is intra or inter coded, the prediction block size and the prediction mode if intra coding is used, and the motion partition size and motion vectors used if inter coding is used. A prediction block is subtracted from the input video block, and transform and quantization are then applied on the residual video block as described above.

The quantized coefficients, along with the mode information, may be entropy encoded to form a video bitstream. The quantized coefficients may also be inverse quantized and inverse transformed to form the reconstructed residual block, which can be added back to the prediction video block (intra predicted block or motion compensated block depending on the coding mode chosen) to form the reconstructed video block. An in-loop or post-loop filter may be applied to reduce the visual artifacts in the reconstructed video signal. The reconstructed video block is finally stored in the reference frame buffer (i.e., memory) for use of coding of future video blocks.

In some examples, the transform coefficient encoding techniques described in this disclosure may be performed by VLC encoding module 260 of FIG. 2 by using VLC tables 264. Again, although VLC tables 264 are illustrated within entropy coding module 244, VLC tables 274 may actually be stored in a memory location (such as memory 245) and accessed by VLC encoding module 272 in the coding process. The reciprocal transform coefficient decoding techniques of this disclosure may be performed by VLC decoding module 370 of FIG. 3 by applying VLC tables 374. As with VLC module 260, with VLC decoding module 370, VLC tables 374 are illustrated within entropy decoding module 344. This illustration, however, is for demonstrative purposes. In actuality, VLC tables 374 may be stored in a memory location (such as memory 345) and accessed by VLC module 370 in the decoding process. The term “coding,” as used herein, refers to any process that includes encoding, decoding or both encoding and decoding.

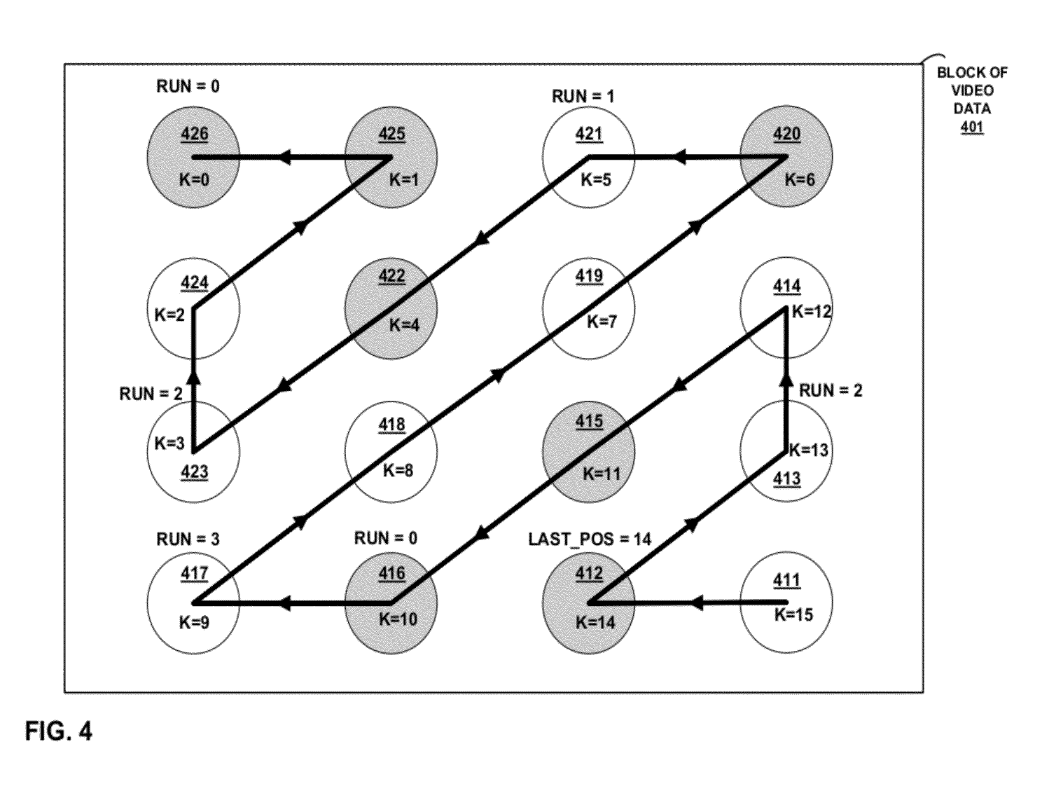

FIG. 4 is a conceptual diagram that illustrates one example of an inverse zig-zag scan consistent with the techniques of this disclosure. The example depicted in FIG. 4 is of a 4×4 block of video data. This example is provided for purposes of explaining the techniques of this disclosure, and is intended to be non-limiting. The techniques described herein may be applicable to any size of video block. For example, the techniques described herein may be applicable to 16×16, 32×32, 64×64, or any other size of block. Furthermore the techniques of this disclosure may be applied to a video block according to any arrangement of video data, including coded units defined according to a quadtree structure, macroblocks, or other blocks of video data. The techniques generally apply to block of data (i.e., transform coefficients) in the transform domain.

As depicted in FIG. 4, block 401 includes sixteen transform coefficients 411-426. According to this example, transform coefficients 411-426 are scanned starting at transform coefficient 411 positioned at a lower right corner of block 401. The inverse zig-zag scan depicted used to generate a one-dimensional ordered coefficient vector of transform coefficients, which may then be transmitted according to an entropy encoded bitstream. The inverse zig-zag scan depicted in FIG. 4 is provided for exemplary purposes only. The various techniques described herein may also be applicable to other types of coefficient scans of transform coefficients, such as a zig-zag, horizontal, vertical, or other type of scan.

According to the example of FIG. 4, block 401 includes transform coefficients 411-426 that may include both non-zero and zero magnitude coefficients. A non-zero coefficient may refer to a quantized transform coefficient with a magnitude greater than zero (e.g., |level| is greater than zero), while a zero value coefficient may refer to a transform coefficient with a quantized value equal to zero (e.g., |level| is equal to zero). For example as shown in FIG. 4, transform coefficients 412, 415, 416, 420, 422, 425, and 426 (as indicated by shading) are non-zero coefficients, while transform coefficients 411, 413, 414, 417-419, 423, and 424 are zero value transform coefficients.

As described above, an encoder may signal a level_ID value for at least some of transform coefficients 411-426. The level_ID value may indicate a magnitude of the respective transform coefficient. For example level_ID may have a value of zero (0) if a magnitude (level) of a coefficient is equal to one. According to this example, level_ID may have a value of one (1) if the magnitude of the coefficient is greater than one. In some examples, an encoder may not signal a level_ID value for zero value coefficients 411, 413, 414, 417-419, 423, and 424. Instead, run values associated with each significant (non-zero) coefficient may define the presence of previously scanned zero value coefficients.

As also described above, in some examples an encoder may signal a last_pos syntax element associated with a block of video data 401 as depicted in FIG. 4. The last_pos syntax element may indicate a position of a first non-zero transform coefficient of the inverse zig-zag scan depicted in FIG. 4. According to the example of FIG. 4, a first non-zero coefficient of the scan is located at a position k=14 in the inverse zig-zag scan. As such, according to this example, a video encoder 250 may signal a last_pos value of 14 to a decoder 350.

As also described above, in some examples of a run encoding mode, an encoder 250 may determine a run value for at least some of transform coefficients 411-426. The run value may indicate a number of quantized coefficients with an magnitude equal to zero between a current (currently coded) coefficient and a next non-zero coefficient in an inverse zig-zag scan order. According to one example, run may have a value in a range from zero to k+1, wherein k is a position index value of the current coefficient in a scan. Position k may also be described to as a number of coefficients between a current coefficient and a last coefficient in scan order. Such a last coefficient may comprise a last coefficient in inverse zig-zag scan order (e.g., coefficient 426 in the example of FIG. 4). In some examples, an encoder may determine a run value associated with each non-zero coefficient of block 401.

FIG. 4 depicts run values that may be signaled as part of an entropy encoded bit stream after each of non-zero transform coefficients 412, 415, 416, 420, 422, 425, and 426 are coded. For example, as shown in FIG. 4, after transform coefficient 412 (a first non-zero coefficient of the depicted inverse zig-zag scan) is coded, the encoded bitstream may signal a run value of run=2, meaning there are two zero value transform coefficients (413, 414) between transform coefficient 412 and a next non-zero coefficient (coefficient 415). As also shown in FIG. 4, after coefficient 415 is coded, the encoded bitstream may signal a run value of run=0, indicating that there are no zero value coefficients between coefficient 415 and the next non-zero coefficient in the scan order (coefficient 416). As also shown in FIG. 4, after coefficient 416 is coded, the encoded bitstream may signal a run value of run=3, indicating that there are three zero value coefficients (417-419) between transform coefficient 416 and a next non-zero coefficient (coefficient 420). As also depicted in FIG. 4, after coefficient 420 is coded, the encoded bitstream may signal a run value of run=1, indicating that there is one zero value coefficient (coefficient 421) between coefficient 420 a next non-zero coefficient (coefficient 422). As also depicted in FIG. 4, after coefficient 422 is coded, the encoded bitstream may signal a run value run=2, indicating that there are two zero value coefficients (coefficients 423-424) between coefficient 422 and a next non-zero coefficient (coefficient 425). As also depicted in FIG. 4, after coefficient 425 is coded, the encoded bitstream may signal a run value of run=0, indicating that there are no zero value coefficients between coefficients 425 and 426 in the scan order.

According to a run coding mode, an encoder 250 may determine values for one or more of last_pos, run, and/or level_ID syntax elements associated with a of a block 401 of video data, and signal one or more of the determined last_pos, run and/or level_ID values as a VLC code word. A decoder 350 may receive such a VLC code word, and use the VLC code word to determine the signaled values for last_pos, run and/or level_ID. The decoder 350 may use the determined run and level_ID values to decode the transform coefficient.

According to the example of FIG. 4, after coefficient 412 is coded, coefficient 413 becomes the current coefficient. A run value run=2 and a level_ID value with respect to coefficient 415 may be signaled in the encoded bitstream (e.g., jointly coded, such as using a concatenated value), based on the position index value k (which is equal to 13 in the example of FIG. 4) for coefficient 413. After coefficient 415 has been coded, coefficient 416 becomes the current coefficient. A run value of 0 and the level_ID value of coefficient 416 may be signaled in the encoded bitstream (e.g., jointly), based on the position index value k (equal to 10 in the example of FIG. 4) of coefficient 416. After coefficient 416 has been coded, coefficient 417 becomes the current coefficient, a run value of 3 and the level_ID value of coefficient 420 may be signaled (e.g., jointly), based on the position index value (equal to 6 in the example of FIG. 4) of coefficient 420 in the scan. In some examples, the encoder may continue to determine and signal run and level_ID values with respect to coefficients 421-426, until coefficient 426 is coded.

To signal determined last_pos, run and/or level_ID syntax elements as a VLC code word, encoder maps from the determined last_pos, run and/or level_ID associated with the transform coefficient to a code number cn. The code number cn may then be used to access a VLC table of a plurality of VLC tables to determine a VLC code word that represents the determined last_pos, run and/or level_ID.

To use the VLC code word to determine the signaled last_pos, run and/or level_ID syntax elements, decoder 350 determines a code number cn based on a received VLC code word, and maps the code number cn to values associated with the last_pos, run and/or level_ID syntax elements. The decoder may then use the mapped last_pos, run and/or level_ID values to decode the transform coefficient.

In some examples, one or more of the techniques described herein may be used in combination with other techniques described herein to code a block of video data. For example, a encoder or decoder may map between a last_pos syntax element and a level_ID syntax element and a code number cn based on a scaling factor S. The encoder or decoder may determine the scaling factor S based on a size of a block of video data being coded. For example, the encoder or decoder may use a different scaling factor S depending on whether the block of video data 401 has a 4×4 size (e.g., that includes sixteen transform coefficients as shown in the example of FIG. 4), than the coder would use if the block of video data is a 8×8, a 16×16, a 32×32, or a 64×64 size. In some examples, to map based on the scaling factor S the encoder or decoder may not access a mapping table of a plurality of mapping tables stored in memory, as described above according to other video coding techniques. Instead, the encoder or decoder may map between last_pos, level_ID, and the code number cn based on a structured mapping that defines a relationship between values of last_pos, level_ID, and the code number cn.

According to other aspects of this disclosure, an encoder or decoder may map between a code number cn and a VLC codeword that represents last_pos and level_ID syntax elements, by accessing a VLC table of a plurality of VLC tables stored in memory. According to these aspects, the encoder or decoder may select the VLC table from the plurality of VLC tables based on a VLC table index value that is adaptively updated base on a scaling factor M. The encoder or decoder may determine the scaling factor M based on a size of a block of video data being coded. For example, the scaling factor M may have a different value depending on whether the block of video data has a 4×4 size as depicted according to the example of FIG. 4, or whether the block of video data has an 8×8, 16×16, 32×32, or a 64×64 size. In some examples, such a VLC table index value may be adaptively updated for each block of video data coded by a coder.

According to still other aspects of this disclosure, for at least one other transform coefficient of a block of video data (e.g., other than a first non-zero coefficient of the inverse zig-zag scan depicted in FIG. 4), an encoder or decoder may also map between run and level_ID syntax elements associated with a block of video data and a code number cn. For example, according to these aspects, an encoder or decoder may map between a code number cn that represents run and level_ID syntax elements and a VLC code word that represents the run and level_ID syntax elements based on a coded block type of a block of video data being coded. For example, if the block of video data has a first coded block type, the encoder or decoder may select a first VLC table of a plurality of VLC tables stored in memory. However, if the block of video data has a second coded block type different than the first coded block type, the encoder or decoder may select a second VLC table different than the first VLC table. According to other examples, the encoder or decoder may map between the code number cn and a VLC codeword based on a mathematical relationship, based on the coded block type of the block of video data being coded.

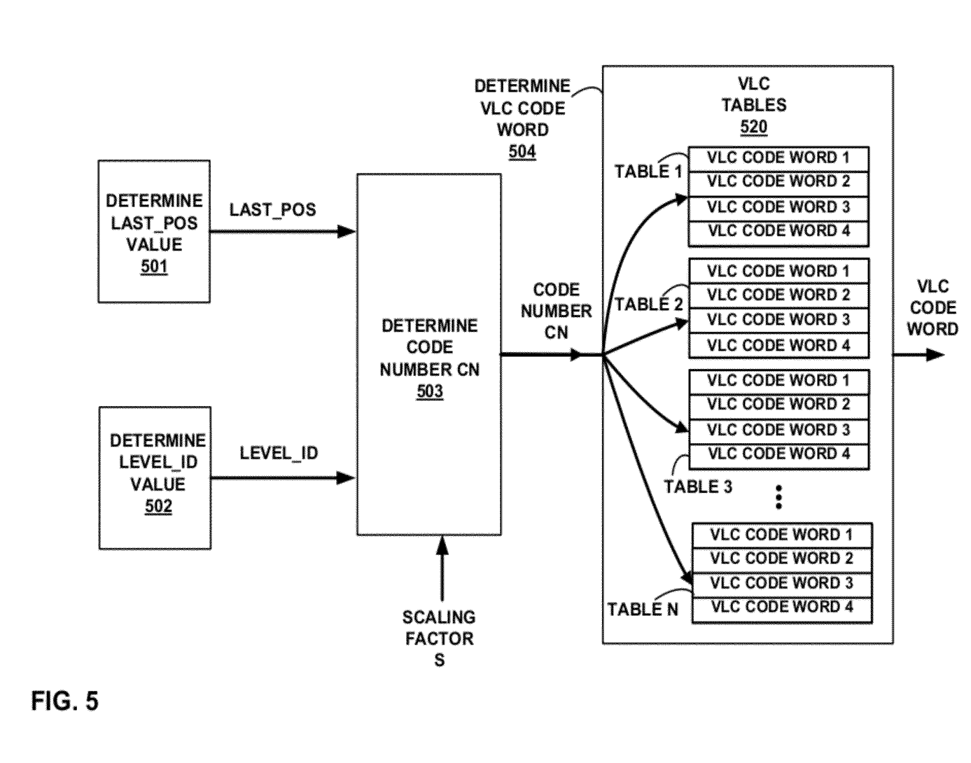

FIG. 5 is a conceptual diagram that depicts one example of a technique for mapping between last_pos and level_ID syntax elements and a code number cn according to some aspects of this disclosure. For exemplary purposes, the technique of FIG. 5 is described with reference to encoder 250 depicted in FIG. 2, however other devices may be used to perform the techniques depicted in FIG. 5.

According to the technique of FIG. 5, video encoder 250 may determine a value for a last_pos syntax element associated with a block of video data (501). For example, video encoder 250 may determine a position k of a first non-zero coefficient of a block, and assign the last_pos syntax element that indicates the position of the first non-zero coefficient of the block. As also shown in FIG. 5, video encoder 250 may determine a level_ID value for the first (in inverse zig-zag scan order) non-zero coefficient of the block of video data (502). For example, video encoder 250 may determine a magnitude of the first non-zero coefficient. If the determined magnitude is greater than one, video encoder 250 may assign a value of one (1) to the level_ID syntax element. However, if the determined magnitude is equal to one, video encoder 250 may assign the level_ID syntax element a value of zero (0).

As also shown in FIG. 5, according to one aspect of this disclosure, video encoder 250 may map from the determined values for the last_pos and level_ID syntax elements to a code number cn based on a scaling factor S (503). For example, video encoder 250 may assign the code number cn a value dependent on a value of the scaling factor S. Video encoder 250 may determine the scaling factor S based on a size of the block of video data being encoded. For example, the scaling factor S may have a different value, depending on whether the block of video data being encoded has a size of 4×4, 8×8, 16×16, 32×32, 64×64, or another size. In some examples, video encoder 250 may map from the determined last_pos and level_ID syntax element values to the code number cn using a structured mapping that defines a relationship between the last_pos and level_ID values and the code number cn. In this manner, video encoder 250 may not access a mapping table of a plurality of mapping tables stored in memory to determine the code number cn based on the scaling factor S.

As also depicted in FIG. 5, once video encoder 250 has determined a code number cn, video encoder 250 may use the code number cn to access a VLC table of a plurality of VLC tables 520 (e.g., VLC tables 262 depicted in FIG. 2) stored in a memory (e.g., memory 245 depicted in FIG. 2) associated with video encoder 250. For example, video encoder 250 may input the code number cn into a selected VLC table to determine the VLC code word.

As depicted in FIG. 5, video encoder 250 may have access to a plurality of VLC tables 520, table 1-table N. The plurality of VLC tables 520 depicted in FIG. 5 are provided for exemplary purposes only. In some examples, plurality of VLC tables 520 may include more, or fewer, VLC tables than depicted in FIG. 5. Furthermore, according to the example of FIG. 5, each of VLC tables 1-N only includes four VLC codewords. In some examples, one or more of VLC tables 1-N may include more, or fewer, VLC codewords.

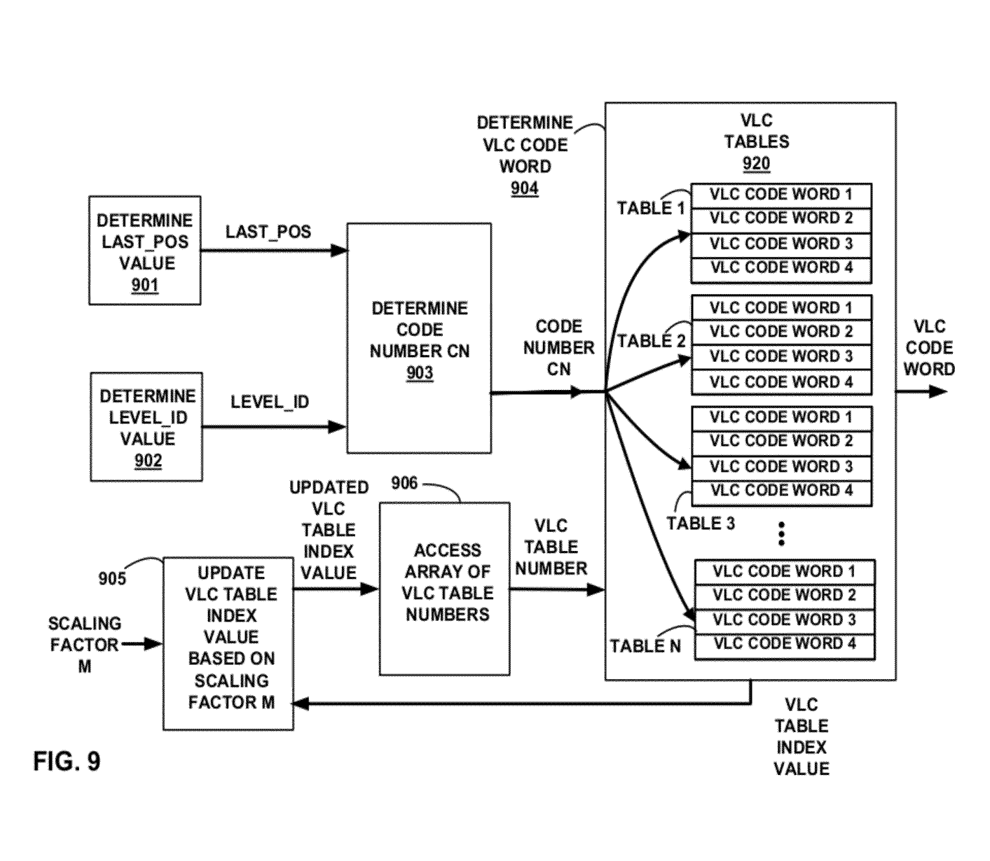

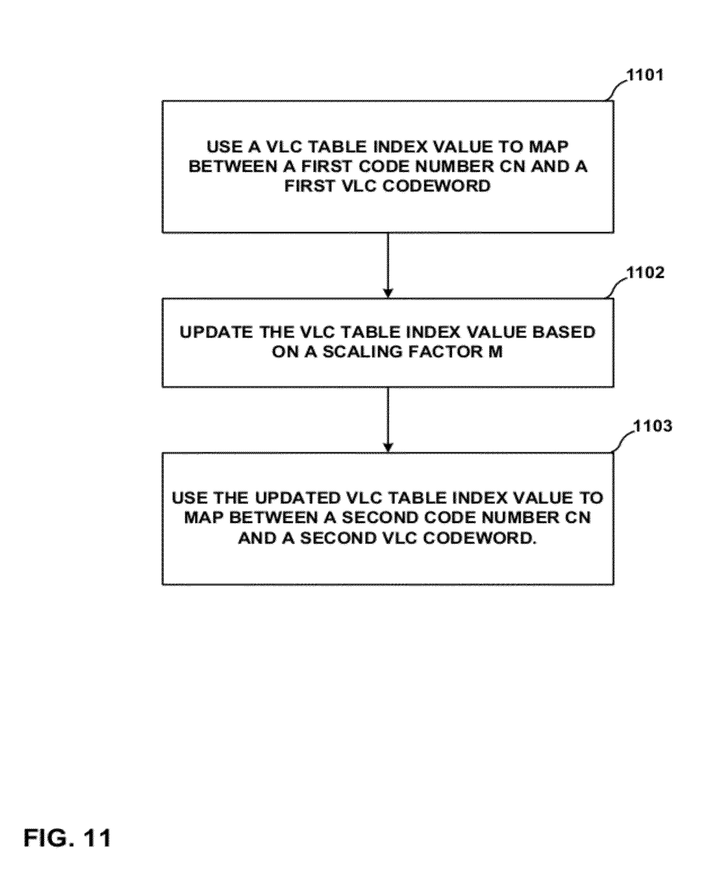

According to the example of FIG. 5, video encoder 520 may select one of VLC tables 1-N for use to determine a VLC codeword. The VLC code word may be determined based on a code number cn that was determined based on a scaling factor S as described above. For example, video encoder 250 may select the respective VLC table 1-N based on a VLC table index value. In some examples, the VLC table index value is updated based on a scaling factor M associated with a block of video data being encoded, as described in further detail below with respect to FIGS. 9 and 11. In other examples, the VLC table index value is not updated based on such a scaling factor M. The techniques depicted in FIG. 5 above may be advantageous, because a video encoder 250 configured to operate according to these techniques may code different sizes of blocks of video data with improved quality and/or efficiency of coding.

Example 1 below is one example of pseudo code that may be used by a video encoder 250 to map from last_pos and level_ID syntax elements to a code number cn based on a scaling factor S according to some aspects of this disclosure. This pseudo code of Example 1 may be stored in memory (e.g., memory 245) of video encoder 250 so that encoder 250 is able to perform such mapping when needed.

### Example 1

```
if (level_ID == 0) {
  cn=((last_pos + (last_pos/S))/S)+last_pos;
}
else{
  if (last_pos<S) {
    cn=S*(last_pos+1);
  }
  else{
    cn = S*S + last_pos;
  }
}
```

The pseudo code of Example 1 may operate to map from determined last_pos and level_ID syntax elements to a code number cn using a structured mapping based on determined values for the level_ID and last_pos syntax elements. In this manner, the video encoder 250 may map to determine the code number cn for a given pair of last_pos and level_ID values without accessing a mapping table of a plurality of mapping tables stored in a memory associated with video encoder 250, which may be undesirable where an amount of memory accessible to video encoder 250 is limited.

In the pseudo code of Example 1, the scaling factor S may be selected based on a size of a block of video data being coded. Also according to the pseudo code of Example 1, the operation “/” represents an integer division operation in which a fractional part (i.e., remainder) of a division is discarded.

As shown by the pseudo code of Example 1, video encoder 250 may determine a value associated with a level_ID syntax element and a value associated with a last_pos syntax element. If the level_ID syntax element has a value equal to zero (0) video encoder 250 may assign the code number cn the sum of last_pos plus last_pos divided by the scaling factor S, divided by the scaling factor S, plus last_pos. However, if the level_ID syntax has a value not equal to zero (0) (e.g., level_ID has a value of one (1)), video encoder 250 may compare a value of the last_pos syntax element to the scaling factor S. If the value of last_pos is less than the scaling factor S, video encoder 250 may assign the code number cn a value of the scaling factor S times the sum of last_pos and one (1). However, if the value of last_pos is greater than or equal to the scaling factor S, then video encoder 250 may assign the code number cn the sum of last_pos and the scaling factor S squared.

In this manner, video encoder 250 may perform a structured mapping to determine a code number cn bases on determined level_ID and last_pos syntax elements, based on a scaling factor S. Again, the scaling factor S may be determined based on a size of a block of video data being coded. For example, the scaling factor S may have a first value for an 8×8 block of video data, and a second, different value for a 16×16 block of video data. By performing a structured mapping as described above with respect to FIG. 5 and the pseudo code of Example 1, video encoder 250 may not access a mapping table of a plurality of mapping tables stored in memory. As a result, memory that may have been used to perform such a mapping may be used for other purposes, which may thereby improve an efficiency and/or quality of coding performed by encoder 250 in comparison to table-based mapping techniques.

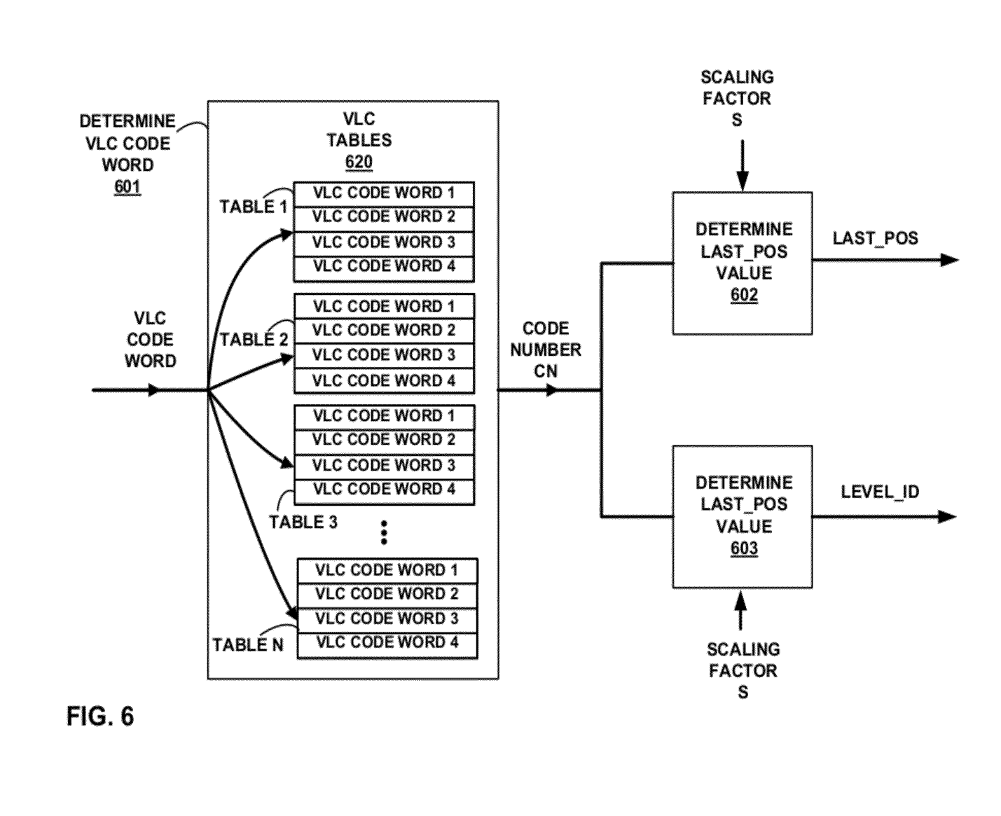

FIG. 6 is a conceptual diagram that depicts one example of a technique for mapping between a code number cn and last_pos and level_ID syntax elements according to some aspects of this disclosure. For exemplary purposes, the technique of FIG. 6 is described with reference to video decoder 350 depicted in FIG. 3, however other devices may be used to perform the techniques depicted in FIG. 6.

According to the technique of FIG. 6, video decoder 350 may determine a code number cn (601). For example, as shown in FIG. 6, video decoder 350 may determine the code number cn based on a received VLC codeword. To determine the code number cn, video decoder 350 may select a VLC table of a plurality of VLC tables 620.

As depicted in FIG. 6, video decoder 350 may have access to a plurality of VLC tables 620, table 1-table N. The plurality of VLC tables 620 depicted in FIG. 6 are provided for exemplary purposes only. In some examples, plurality of VLC tables 620 may include more, or fewer, VLC tables 620 than depicted in FIG. 6. Furthermore, according to the example of FIG. 6, each of VLC tables 620 1-N only includes four VLC codewords. In some examples, one or more of VLC tables 620 1-N may include more, or fewer, VLC codewords.

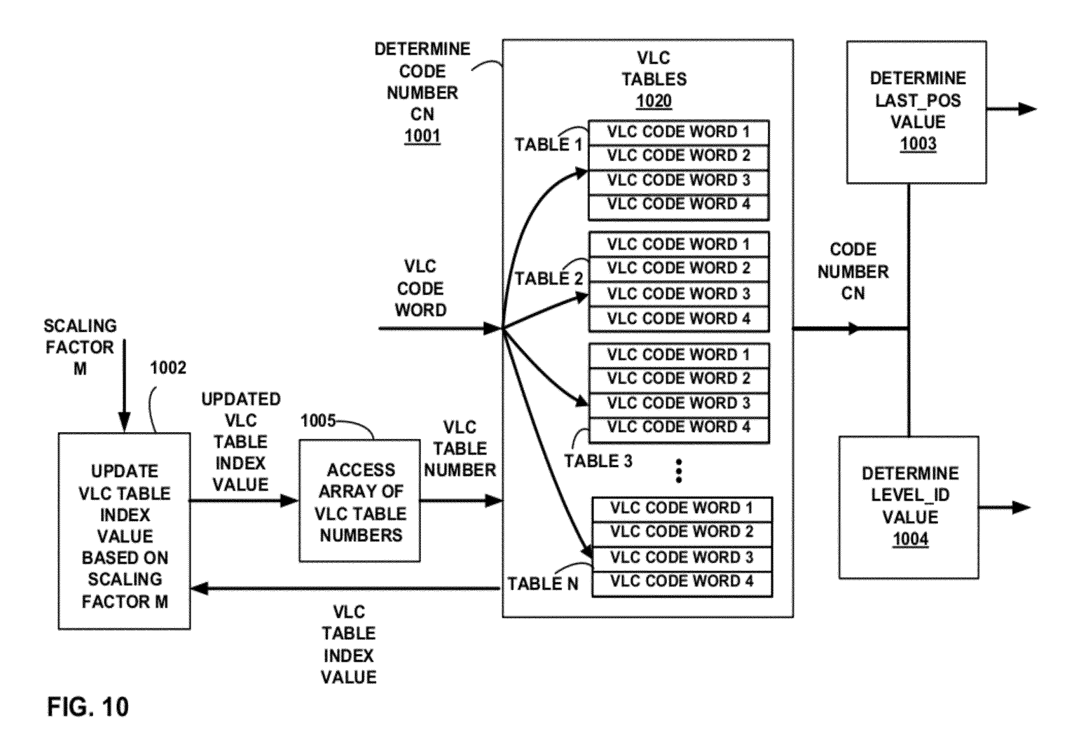

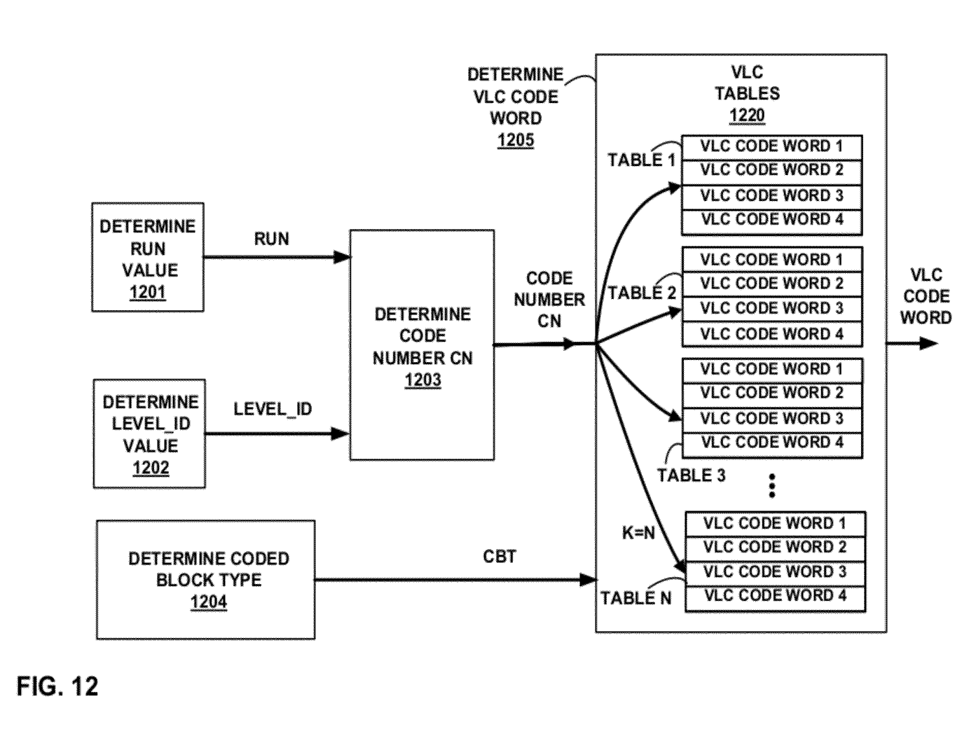

In some examples, video decoder 350 may select the respective VLC table of the plurality of VLC tables 620 based on a VLC table index value. Such a VLC table index may be adaptively updated. For example, such a VLC table index value may, in some examples, be adaptively updated based on a scaling factor M, as described herein with respect to FIGS. 10 and 12.

As also depicted in FIG. 6, video decoder 350 may map from the determined code number cn to a last_pos syntax element based on a scaling factor S (602). For example, video decoder 350 may assign the last_pos syntax element a value dependent on a value of the scaling factor S. As also depicted in FIG. 6, video decoder 350 may also map from the determined code number cn to a level_ID syntax element based on the scaling factor S (603). For example, video decoder 350 may assign the level syntax element a value dependent on a value of the scaling factor S. Video decoder 350 may determine the scaling factor S based on a size of the block of video data being decoded. For example, the scaling factor S may have a different value, depending on whether the block of video data being encoded has a size of 4×4, 8×8, 16×16, 32×32, 64×64, or another size.

In some examples, video decoder 350 may map from the determined code number cn to the last_pos and level_ID syntax elements using a structured mapping that defines a relationship between the code number cn and the last_pos and level_ID syntax element. In this manner, video encoder 250 may avoid the need to use a mapping table to determine the level_ID and last_pos syntax elements based on the scaling factor S. Once video decoder 350 has determined the level_ID and last_pos syntax elements based on the mapping depicted in FIG. 6, video decoder 350 may use the determined level_ID and last_pos syntax elements to decode the block of video data. The techniques depicted in FIG. 6 may be advantageous because a video decoder 350 configured to operate according to these techniques may code different sizes of blocks of video data with improved quality and/or efficiency of coding.

Example 2 below illustrates one example of pseudo code that may be used by a video decoder 250 to map from a code number cn to last_pos and level_ID syntax elements based on a scaling factor S according to some aspects of this disclosure. The pseudo code of Example 2 may be stored in memory (e.g., memory 345) of video decoder 350 so that encoder 350 is able to perform such mapping when needed.

### Example 2

```
if(cn <= S*S+S){
  if(cn!=0 && (cn%S)==0){
    level_ID = 1;
    last_pos = cn/S−1;
  }
  else{
    level_ID = 0;
    last_pos = cn - cn/S;
  }
}
else{
  level_ID = 1;
  last_pos = cn - S*S;
}
```

In the pseudo code of Example 2, the scaling factor S may be selected based on a size of a block of video data being decoded. Also according to the pseudo code of Example 2, the operation “/” represents an integer division operation in which a fractional part (i.e., remainder) of a division is discarded. Also according to the pseudo code of Example to, the operation “%” represents a modulo operation in which is equal to a fractional part (i.e., remainder) of a division operation.

As shown by the pseudo code of Example 2, video decoder 350 may determine a value associated with a cn. If the code number cn has a value less than or equal to equal to the scaling factor S times the scaling factor S (i.e., the scaling factor S squared) plus the scaling factor S, video decoder 350 may determine whether or not the code number cn is equal to zero, and a remainder of the code number cn divided by the scaling factor S. If the code number cn is not equal to zero (0), and the remainder of the code number cn divided by the scaling factor S is equal to zero (0), then video decoder 350 may assign the level_ID sytax element a value of one (1), and assign the last_pos syntax a value of the code number divided (e.g., integer division) by the scaling factor S, minus one (1). However, if the code number is equal to zero, or if the remainder of the code number cn divided by the scaling factor S is a value other than zero, video decoder may assign the level_ID syntax element a value of zero (0), and the last_pos syntax element a value of the code number cn divided by (e.g., integer division) the scaling factor S, subtracted from the code number cn.

As also shown in the pseudo code of Example 2, if the code number cn has a value greater than the scaling factor S times the scaling factor S (i.e., the scaling factor S squared) plus the scaling factor S, video decoder 350 may assign the level_ID syntax element a value of one (1), and the last_pos syntax element a value of the code number cn minus the scaling factor S times the scaling factor S (the scaling factor S squared).

The pseudo code of Example 2 may operate to map from a determined code number cn to last_pos and level_ID syntax elements based on the code number cn and a scaling factor S. In this manner, the video decoder 350 may determine the last_pos and level_ID syntax elements without accessing a mapping table of a plurality of mapping tables stored in a memory associated with video decoder 350. The use of mapping tables may be undesirable where an amount of memory accessible to video decoder 350 is limited.

In this manner, video decoder 350 may perform a structured mapping to determine level_ID and last_pos syntax elements based on a code number cn, based on a scaling factor S. Again, the scaling factor S may be determined based on a size of a block of video data being coded. For example, the scaling factor S may have a first value for an 8×8 block of video data, and a second, different value for a 16×16 block of video data. By performing a structured mapping as described above with respect to FIG. 6 and the pseudo code of Example 2, video decoder 350 may avoid the need to use a mapping table of a plurality of mapping tables stored in memory. As a result, memory that may have been used to perform such a mapping may be used for other purposes, which may thereby improve an efficiency and/or quality of coding performed by video decoder 350 in comparison to table-based mapping techniques.

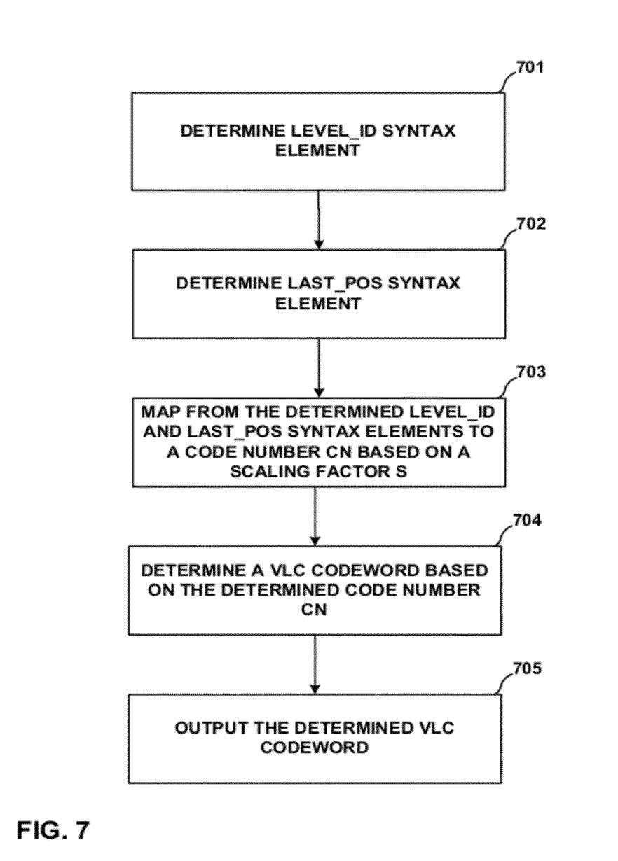

FIG. 7 is a flow diagram that illustrates one example of a method for encoding a block of video data consistent with the techniques described herein. The method depicted in FIG. 7 is described as performed by video encoder 250 depicted in FIG. 2. However other devices may be used to perform the technique of FIG. 7.

As shown in FIG. 7, video encoder 250 may determine a value of a level_ID syntax element associated with a transform coefficient of a block of video data (701). Video encoder 250 may also determine a last_pos syntax element associated with the block of video data (702). The last_pos syntax element may indicate a position of a first non-zero coefficient in an inverse scan order (i.e., a last non-zero coefficient in a non-inverse scan order). The level_ID syntax element may indicate a magnitude of the last non-zero coefficient. For example the level_ID syntax element may indicate whether the last non-zero coefficient has a magnitude of one, or greater than one.

As also shown in FIG. 7, video encoder 250 may map from the determined level_ID syntax element and the determined last_pos syntax element to a code number cn based on a scaling factor S (703). For example, video encoder 250 may perform a structured mapping that assigns the code number cn a value based on a value of the last_pos syntax element, a value of the level_ID syntax element, and/or a value of the scaling factor S. The scaling factor S may be based on a size of the block of video data being encoded by encoder 250.

As also shown in FIG. 7, video encoder 250 may determine a VLC codeword based on the determined code number cn (704). For example, video encoder 250 may select a VLC table of a plurality of VLC tables 520 stored in memory, and use the selected VLC table to determine the codeword based on the code number cn. Such a VLC table may be selected based on a VLC table index value, which may be adaptively updated as transform coefficients are encoded by video encoder 250. Such a VLC table index value may or may not be adaptively updated according to a scaling factor M, as described herein with respect to FIGS. 9 and 11.

As also depicted in FIG. 7, video encoder 250 may output the determined VLC codeword (705). For example, video encoder 250 may output the determined VLC codeword to a decoder (e.g., video decoder 350). The video decoder may use the VLC codeword to determine the level_ID and last_pos syntax elements, and use the determined level_ID and last_pos syntax elements to decode the block of video data.

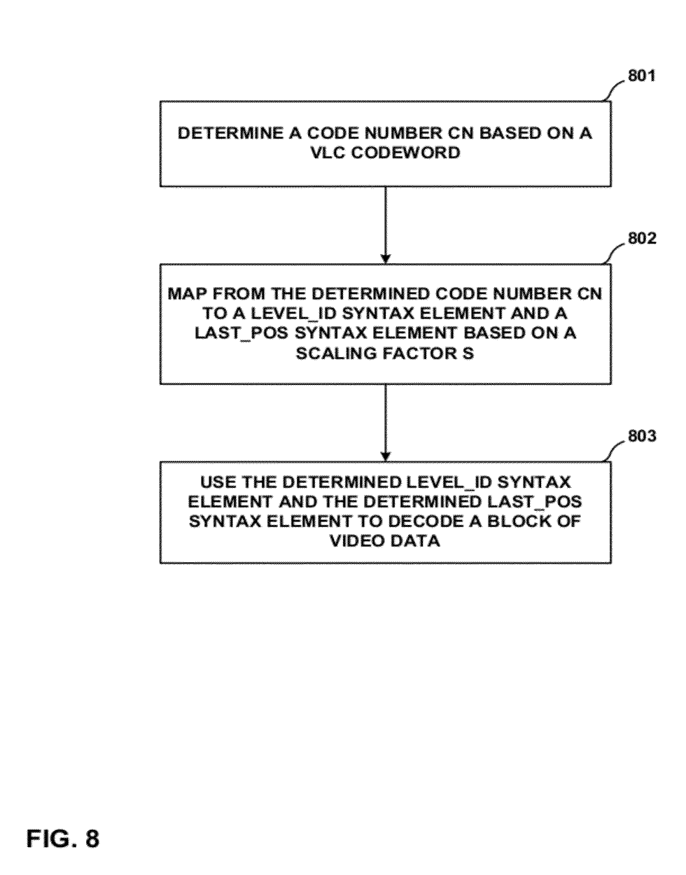

FIG. 8 is a flow diagram that illustrates one example of a method for decoding a block of video data consistent with the techniques described herein. The method depicted in FIG. 8 is described as performed by video decoder 350 depicted in FIG. 3. However, other devices may be used to perform the technique of FIG. 8.

As shown in FIG. 8, video decoder 350 may determine a code number cn based on a VLC codeword (801). For example, video decoder 350 may select a VLC table of a plurality of VLC tables 620 stored in memory, and use the selected VLC table to determine the code number cn based on the received VLC codeword. Such a VLC table may be selected based on a VLC table index value, which may be adaptively updated as transform coefficients are decoded by video decoder 350. The a VLC table index value may or may not be adaptively updated according to a scaling factor M, as described herein with respect to FIGS. 10 and 11.

As also shown in FIG. 8, video decoder 350 may map from the determined code number cn to a level_ID syntax element and a last_pos syntax element based on a scaling factor S (802). For example, video decoder 350 may perform a structured mapping that assigns the level_ID and last_pos syntax elements respective values, based on a value of one or more of the code number cn and a value of the scaling factor S. The scaling factor S may be based on a size of the block of video data being decoded by video decoder 350.

As also shown in FIG. 8, video decoder may use the determined level_ID syntax element and the determined last_pos syntax element to decode the block of video data (803). For example, video decoder 350 may use the last_pos syntax element to determine a position of a first non-zero coefficient in an inverse scan of the block of video data. Video decoder 350 may also use the determined level_ID syntax element to determine whether the first non-zero coefficient of the inverse scan has a magnitude of one, or a magnitude greater than one.

FIG. 9 is a conceptual diagram that depicts one example of a technique for determining, by an encoder, a VLC codeword that represents determined level_ID and last_pos syntax elements according to some aspects of this disclosure. For exemplary purposes, the technique of FIG. 9 is described with reference to encoder 250 depicted in FIG. 2, however other devices may be used to perform the techniques depicted in FIG. 9.

According to the technique of FIG. 9, video encoder 250 may determine a value for a last_pos syntax element associated with a block of video data (901). For example, video encoder 250 may determine a position k of a first non-zero coefficient of a block, and assign the last_pos syntax element a value that indicates the position of the first non-zero coefficient of the block, e.g. set the value of last_pos equal to k. As also shown in FIG. 9, video encoder 250 may determine a level_ID value for the first (in inverse zig-zag scan order) non-zero coefficient of the block of video data (902). For example, video encoder 250 may determine a magnitude of the first non-zero coefficient. If the determined magnitude is greater than one, video encoder 250 may assign a value of one (1) to the level_ID syntax element. However, if the determined magnitude is equal to one, video encoder 250 may assign the level_ID syntax element a value of zero (0).

As also shown in FIG. 9, video encoder 250 may map from the determined values for the last_pos and level_ID syntax elements to a code number cn (903). For example, video encoder 250 may map from the last_pos and level_ID syntax elements to the code number cn based on a structured mapping. In some examples, such a structured mapping may be based on a scaling factor S, as described above with respect to FIGS. 5 and 7. In other examples, video encoder 250 may not use a structured mapping to map from the last_pos and level_ID syntax elements to the code number cn. Instead, according to these examples, video encoder 250 may map based on accessing a mapping table of a plurality of mapping tables stored in a memory associated with video encoder 250 (e.g., memory 245 depicted in FIG. 2).

As also shown in FIG. 9, video encoder 250 may use the determined code number cn to determine a VLC codeword that represents the level_ID and last_pos syntax elements (904). For example, as shown in FIG. 9, video encoder 250 may use the code number cn as an input value for a VLC table of a plurality of VLC tables 920 (e.g., VLC tables 262 depicted in FIG. 2) stored in a memory (e.g., memory 245 depicted in FIG. 2) associated with video encoder 250. For example, video encoder 250 may input the code number cn into a selected VLC table to determine the VLC codeword.

As depicted in FIG. 9, video encoder 250 may have access to a plurality of VLC tables 920, table 1-table N. The plurality of VLC tables 920 depicted in FIG. 2 are provided for exemplary purposes only. In some examples, plurality of VLC tables 920 may include more, or fewer, VLC tables than depicted in FIG. 9. Furthermore, according to the example of FIG. 9, each of VLC tables 1-N only includes four VLC codewords. In some examples, one or more of VLC tables 1-N may include more, or fewer, VLC codewords.

According to some aspects of this disclosure, as illustrated in FIG. 9, video encoder 250 may select the one of the respective VLC tables 1-N 920 based on a VLC table index value that is adaptively updated as video encoder 250 encodes blocks of video data, based on a scaling factor M (905). For example, video encoder 250 may use an adaptively updated VLC table index value to access an array of VLC table numbers to determine a VLC table number (906). Video encoder 250 may use the determined VLC table number to select from among a plurality of VLC tables 920.

In some examples, video encoder 250 may be configured to store a plurality of such arrays of VLC table numbers. According to these examples, video encoder 250 may select a particular array of VLC table numbers from such a plurality of arrays based on one or more characteristics of a block of video data being encoded. For example, video encoder 250 may store different VLC table arrays based on one or more of a prediction type (e.g., intra or inter coded), a color component (e.g., luma or chroma), or other characteristic of a block of video data being encoded.

Like scaling factor S described above with respect to FIGS. 9 and 11, the scaling factor M may be determined based on a size of a block of video data being encoded by encoder 250. The scaling factor M may or may not be the same as scaling factor S described above.

According to the example of FIG. 9, video encoder 250 may select a particular VLC table from a plurality of VLC tables 920 stored in a memory of video encoder 250, based on a VLC table number determined based on a VLC table index value that is adaptively updated based on the scaling factor M. For example, each time video encoder 250 encodes a block of video data, if the block of video data has a first size (e.g., an 8×8 block of video data), video encoder 250 may assign the VLC table index value a first value. However, if the block of video data has a second size (e.g., a 16×16 block of video data) different than the first size, video encoder 250 may assign the VLC table index value a second value different than the first value. Video encoder 250 may use the selected VLC table index value, with either of the first or second value, to encode the values of last_pos and level_ID syntax elements for a next block of video data. For example, video encoder 250 may use such an adaptively updated VLC table index value to determine a VLC table number. Video encoder 250 may use the determined VLC table number to select at least one of VLC tables 920 depicted in FIG. 9 to determine a VLC codeword that represents the values of the last_pos and level_ID syntax elements.

According to the technique depicted in FIG. 9, video encoder 250 may be configured to encode blocks of video data of different sizes. For example, according to the techniques of FIG. 9, video encoder 250 may determine a VLC codeword that represents last_pos and level_ID syntax elements associated with a block of video data with improved coding efficiency and/or quality, for different sized blocks of video data, in comparison to other techniques.

FIG. 10 is a conceptual diagram that depicts one example of a technique for determining, by a decoder, a code number cn based on a VLC codeword that represents level_ID and last_pos syntax elements according to some aspects of this disclosure. For exemplary purposes, the technique of FIG. 10 is described with reference to video decoder 350 depicted in FIG. 3. However, other devices may be used to perform the techniques depicted in FIG. 10.

According to the technique of FIG. 10, video decoder 350 may receive a VLC codeword. For example, video decoder 350 may receive the VLC codeword by accessing or receiving the VLC codeword from a memory 345 associated to the decoder 350, or via a communications module (e.g., receiver 128 depicted in FIG. 1) of video decoder 350.

As depicted in FIG. 10, video decoder 350 may determine a code number cn based on the VLC codeword (1001). For example, as shown in FIG. 10, video decoder 350 may decode a VLC codeword from a bitstream using a VLC table of a plurality of VLC tables 1020 (e.g., VLC tables 372 depicted in FIG. 3) stored in a memory (e.g., memory 345 depicted in FIG. 2) associated with video decoder 350. For example, once video decoder 350 decodes a VLC codeword from the bitstream using a selected VLC table, the code number cn associated with that VLC codeword in the selected VLC table may be determined.

As depicted in FIG. 10, video decoder 350 may have access to a plurality of VLC tables 1020, table 1-table N. The plurality of VLC tables 1020 depicted in FIG. 10 are provided for exemplary purposes only. In some examples, the plurality of VLC tables 1020 may include more, or fewer, VLC tables than depicted in FIG. 10. Furthermore, according to the example of FIG. 10, each of VLC tables 1-N only includes four VLC codewords. In some examples, one or more of VLC tables 1-N may include more, or fewer, VLC codewords.

According to some aspects of this disclosure, as illustrated in FIG. 10 video decoder 350 may select the one of the respective VLC tables 1-N 1020 based on a VLC table index value that is adaptively updated as video decoder 350 encodes blocks of video data, based on a scaling factor M (1002). For example, video decoder 350 may use an adaptively updated VLC table index value to access an array of VLC table numbers to determine a VLC table number (1003). Video decoder 350 may use the determined VLC table number to select from among a plurality of VLC tables 1020.

In some examples, video decoder 350 may be configured to store a plurality of such arrays of VLC table numbers. According to these examples, video decoder 350 may select a particular array of VLC table numbers from such a plurality of arrays based on one or more characteristics of a block of video data being encoded. For example, video decoder 350 may store different VLC table arrays based on one or more of a prediction type (e.g., intra or inter coded), a color component (e.g., luma or chroma), or other characteristic of a block of video data being decoded.

Like scaling factor S described above with respect to FIGS. 6 and 8, the scaling factor M may be determined based on a size of a block of video data being decoded by video decoder 350. The scaling factor M may or may not be the same as scaling factor S described above.

According to the example of FIG. 10, video decoder 350 may select a particular VLC table from a plurality of VLC tables 1020 stored in a memory of video decoder 350, a VLC table number determined based on a VLC table index value that is adaptively updated based on the scaling factor M. For example, each time video decoder 350 decodes a block of video data, if the block of video data has a first size (e.g., an 8×8 block of video data), video decoder 350 may assign the VLC table index value a first value. However, if the block of video data has a second size (e.g., a 16×16 block of video data) different than the first size, video decoder 350 may assign the VLC table index value a second value different than the first value. Video decoder 350 may use the selected VLC table to decode a next block of video data. For example, video decoder 350 may use the adaptively updated VLC table index value to determine a VLC table number and then use the determined table number to select one of VLC tables 1020 depicted in FIG. 10. Video decoder 350 may use the determined VLC table to decode a VLC codeword and determine a code number cn associated with the VLC codeword for a next block of video data.

As also shown in FIG. 10, once video decoder 350 has determined the code number cn based on the received VLC codeword as described above, video decoder 350 may determine last_pos syntax element based on the code number cn (1003). As also shown in FIG. 10, once video decoder 350 has determined the code number cn based on the received VLC codeword as described above, video decoder may determine a level_ID syntax element based on the code number cn (1004). To determine the level_ID and last_pos syntax elements, video decoder 350 may map from the determined code number cn to the last_pos and level_ID syntax elements. For example, video decoder 350 may map from the code number cn to the last_pos and level_ID syntax elements based on a structured mapping. In some examples, such a structured mapping may be based on a scaling factor S, as described above with respect to FIGS. 6 and 8. In other examples, video decoder 350 may not use a structured mapping to map from the code number cn to the last_pos and level_ID syntax elements. Instead, according to these examples, video decoder 350 may perform the mappings by using a mapping table of a plurality of mapping tables stored in a memory associated with video decoder 350 (e.g., memory 345 depicted in FIG. 3). Video decoder 350 may further use the determined level_ID and last_pos syntax elements to decode a block of video data. For example, video decoder 350 may use the last_pos syntax element to determine a position of a first non-zero coefficient of an inverse scan. Video decoder 350 may use the level_ID syntax element to determine whether such a first non-zero coefficient has a magnitude of one (1) or greater than one.

According to the technique depicted in FIG. 10, video decoder 350 may be configured to decode blocks of video data of different sizes. For example, according to the techniques of FIG. 10, video decoder 350 may determine last_pos and level_ID syntax elements based on a decoded VLC codeword from a received bitstream with improved coding efficiency and/or quality, for different sized blocks of video data, in comparison to other techniques.

Example 3 below is one example of pseudo code that may be used by a video encoder 250 and/or a video decoder 350 (collectively, “coder 250, 350”) to update a VLC table index value that may be used to select a VLC table of a plurality of VLC tables stored in a memory. For example, video encoder 250 may use the pseudo code of Example 3 to determine a VLC codeword based on a determined code number cn. The video encoder 250 may execute a technique consistent with the pseudo code in order to determine cn from values of level_ID and last_pos syntax elements. In other words, video encoder 250 may determine cn from values of level_ID and last_pos syntax elements based on a structured mapping as described above with respect to FIGS. 5-7. However, in other examples, cn may be determined from values of level_ID and last_pos syntax elements based on a particular mapping table of a plurality of mapping tables stored in memory. In any case, once the code number cn has been determined, video encoder 250 may use the determined code number cn to update the VLC table index value, as depicted according to the example of FIG. 9.

The decoder 350 may use the pseudo code of Example 3 to determine a code number cn based on a received VLC codeword. For example, the video decoder 350 may decode a VLC codeword from received bitstream using a VLC table of a plurality of VLC tables based on a previously determined VLC table index value and, once a code number cn is determined using the decoded VLC codeword from the selected VLC table, execute a technique consistent with the pseudo code of Example 3 to update the VLC table index value, as depicted in the example of FIG. 10.

This pseudo code of Example 3 may be stored in memory (e.g., memory 245, 345) of an encoder 250 and/or decoder 350 and used to update a VLC table index value when needed.

### Example 3

vlcIndex += (cn/M == vlcIndex? 0 : (cn/M < vlcIndex? −1 : 1));
vlcIndex = Min(vlclndex, Q);

The pseudo code of Example 3 may operate to update a VLC table index value based on a scaling factor M, as described above with respect to FIGS. 9 and 10 above. For example, as described above, an encoder 250, decoder 350 may compare the determined code number cn, to a current VLC table index value (e.g., which may be based on one or more previously encoded blocks of video data). As shown by the pseudo code of Example 3, if the code number cn divided by the scaling factor M has a value equal to the VLC table index value, then coder 250, 350 may not change the current VLC table index value. If the code number cn divided by the scaling factor M is less than the VLC table index value, encoder 250, decoder 350 may decrement (i.e. subtract from) the VLC table index value by a value of one (1). If the code number cn divided by the scaling factor M has a value greater than the VLC table index value, encoder 250, decoder 350 may increment (i.e., add to) the VLC table index by a value of one (1).

As also shown in the pseudo code of Example 3, once the VLC table index value has been updated (e.g., incremented, decremented, or left the same), encoder 250, decoder 350 may also compare the updated VLC table index value to an index threshold Q. The index threshold Q may be assigned a value equal to the maximum index value of an array of VLC table numbers. For example, if the VLC table array has 17 elements (with index from 0 to 16), the value Q may be set to 16. According to Example 3, encoder 250, decoder 350 may compare the updated VLC table index value to the index threshold value of 16. If the VLC table index value is equal to or greater than 16, then encoder 250, decoder 350 may assign the updated VLC table index value a value of 16. However, if the updated VLC table index value is not greater than the index threshold Q, encoder 250, decoder 350 may not change the updated VLC table index value. The encoder 250, decoder 350 may use the updated VLC table index value to access a VLC table array, to determine a VLC table number. The encoder 250, decoder 350 may use the determined VLC table number to select a VLC table of a plurality of VLC tables. Encoder 250 may adaptively update the VLC table index value after a current VLC table index number is used to determine a VLC codeword based on a code number cn.

In this manner, encoder 250, decoder 350 may map between a VLC codeword and a code number cn based on a scaling factor M. The scaling factor M may be based on a size of a block of video data being coded. For example, if the block of video data being coded comprises a 8×8 block, the scaling factor M may be assigned a value of one (1). However, if the block of video data being coded comprises 16×16 or 32×32 block, the scaling factor M may be assigned a value of four (4). The scaling factor may also be different for other sized blocks of video data (e.g., 4×4, 64×64). By adaptively updating a VLC table index value based on a scaling factor M as described above with respect to FIGS. 9 and 10, and the pseudo code of Example 3, encoder 250, decoder 350 may be configured to code different sized blocks of video with improved efficiency and/or quality in comparison other techniques.

FIG. 11 is a flow diagram that illustrates one example of a method of coding a block of video data that may be performed by a video encoder 250 and/or a vide decoder 350 consistent with the techniques described herein. The method depicted in FIG. 11 is described as performed by a coder 250, 350 as depicted in FIGS. 2 and 3, respectively, but may instead be performed by another device.

As shown in FIG. 11, encoder 250, decoder 350 may use a VLC table index value to determine a VLC table number from an array of VLC table numbers. Then use the VLC table number to identify a VLC table which may be used to map between a first code number cn and a first VLC codeword (1101). The first code number cn and the first VLC codeword may represent a level_ID syntax element and a last_pos syntax element associated with a first block of video data. In examples where the technique of FIG. 11 is performed by video encoder 250, video encoder 250 may determine the first code number cn based on determined level_ID and last_pos syntax elements associated with the first block of video data and then map between the first code number cn and the first VLC codeword. In examples where the technique of FIG. 11 is performed by video decoder 350, video decoder 350 may map between the first VLC codeword and the first code number cn, to determine the level_ID and last_pos syntax elements associated with the first block of video data based on the first code number cn.

As also shown in FIG. 11, encoder 250, decoder 350 may update a VLC table index value based on a scaling factor M (1102). The scaling factor M may be based on a size of a block of video data being coded. The coder 250, 350 may use the updated VLC table index value to map between a second code number cn and a second VLC codeword (1103). For example, the updated VLC table index value may be used to identify a VLC table number from an array of VLC table numbers. The encoder 250, decoder 350 may use the identified VLC table number to identify a VLC table. The identified VLC table may be used to map between a second code number cn and a second VLC codeword.

In examples wherein the technique of FIG. 11 is performed by video encoder 250, video encoder 250 may determine the second code number cn based on determined level_ID and last_pos syntax elements associated with the second block of video data, then use the second code number cn to determine the second VLC codeword. In examples where the technique of FIG. 11 is performed by video decoder 350, video decoder 350 may map between the second VLC codeword and the second code number cn, then determine the level_ID and last_pos syntax elements associated with the second block of video data based on the second code number cn.

FIGS. 5-11 illustrate techniques that may be used by an encoder and/or a decoder to map between a code number cn and level_ID and last_pos syntax elements associated with a block of video data. In some examples of run mode coding techniques as described herein, an encoder may signal the last_pos and level_ID syntax elements to a decoder, such that the decoder may begin performing an inverse zig-zag scan of coefficients of the block of video data. For one or more coefficients positioned after the first coefficient of the scan, the encoder may signal to the decoder a run syntax element, and a level_ID syntax element. The run syntax element may indicate, to the decoder, a number of zero value coefficients between a current coefficient and next non-zero coefficient of the scan. The level_ID syntax element may indicate whether at least one non-zero coefficient of the scan has a value of one, or greater than one. FIGS. 12-15 depict examples of techniques for coding one or more transform coefficients of a block of video data. More specifically, FIGS. 12-15 illustrate techniques for mapping between a code number cn and a VLC codeword that represents level_ID and run syntax elements associated with a transform coefficient of a block of video data, based on a coded block type of the block of video data. For example, according to these aspects of this disclosure, a coder may map between a code number cn and a VLC codeword based on a position k for a current transform coefficient, as well as whether a block of video data that includes the transform coefficient has an inter-coded chroma, inter-coded chroma, intra-coded luma, or intra-coded chroma coded block type.

FIG. 12 is a conceptual diagram that illustrates one example of a technique that may be performed by a video encoder 250 to encode at least one transform coefficient of a block of video data, consistent with one or more aspects of this disclosure. The technique depicted in FIG. 12 is described as performed by video encoder 250 depicted in FIG. 2, although other devices may be also used to perform the technique.

As depicted in the example of FIG. 12, video encoder 250 may determine a run syntax element associated with a transform coefficient of a block of video data (1201). For example, video encoder 250 may determine a run syntax element that indicates a number of non-zero coefficients between a current coefficient, and a next non-zero coefficient of a scan (e.g., an inverse zig-zag scan). As also depicted in the example of FIG. 12, video encoder 250 may determine a level_ID syntax element (1202). For example, video encoder 250 may determine a level_ID syntax element that indicates whether at least one coefficient of the block of video data has a value of one or greater than one.

As also depicted in FIG. 12, video encoder 250 may determine a code number cn based on the determined run and level_ID syntax elements (1203). For example, video encoder 250 may select and use a mapping table of a plurality of mapping tables stored in a memory associated with the decoder to determine the code number cn. In other examples, video encoder 250 may use a structured mapping to determine the code number cn based on the determined run and level_ID syntax elements.

As also depicted in FIG. 12, video encoder 250 may determine a coded block type (CBT) of the block of video data being encoded. For example, video encoder 250 may determine whether the block of video data has an intra-chroma, intra-luma, inter-luma, or inter-chroma coded block type (1204).

As also depicted in FIG. 12, video encoder 250 may select a VLC table and use the determined code number cn to determine a VLC codeword that represents the run and level_ID syntax elements, based on the determined coded block type of the block of video data (1205). For example, to determine the VLC codeword, video encoder 250 may select a VLC table of a plurality of VLC tables 1220 stored in a memory associated with video encoder 250, and input the code number into the selected table to determine the VLC codeword. As another example, to determine the VLC codeword, video encoder 250 may use a mathematical relationship based on the determined coded block type of the block of video data.

As depicted in FIG. 12, video encoder 250 may have access to a plurality of VLC tables 1220, table 1-table N. The plurality of VLC tables 1220 depicted in FIG. 12 are shown for exemplary purposes only. In other examples, plurality of VLC tables 1220 may include more, or fewer, VLC tables than depicted in FIG. 12. Furthermore, according to the example of FIG. 12, each of VLC tables 1-N only includes four VLC codewords. In some examples, one or more of VLC tables 1-N 1220 may include more, or fewer, VLC codewords.

As described above, according to some aspects of this disclosure, video encoder 250 may select a VLC table of a plurality of VLC tables 1220 based on a coded block type of a block of video data being encoded. For example, for a particular transform coefficient of the block of video data, video encoder 250 may select a first table (e.g., table 2 in the example of FIG. 12) of the plurality of VLC tables 1220 if the block of video data has a first coded block type, and select a second, different table (e.g., table 3 in the example of FIG. 12) if the block of video data has a second coded block type different than the first coded block type. In some examples, video encoder 250 may also select such a VLC table based on a position k of a current transform coefficient, as well as based on the coded block type of the block of video data being coded.

As also depicted in FIG. 12, video encoder 250 may output a VLC codeword that represents the determined run and level_ID syntax elements. For example, video encoder 250 may output the VLC codeword to a decoder (e.g., decoder 350 depicted in FIG. 3), to signal the determined run and level_ID syntax elements to the decoder. In some examples, signaling level_ID and run syntax elements as described above using a VLC codeword determined based on a VLC table selected based on a coded block type of a block of video data as described above may be advantageous, because these techniques may provide for improved coding efficiency and/or quality in comparison to other video coding techniques.

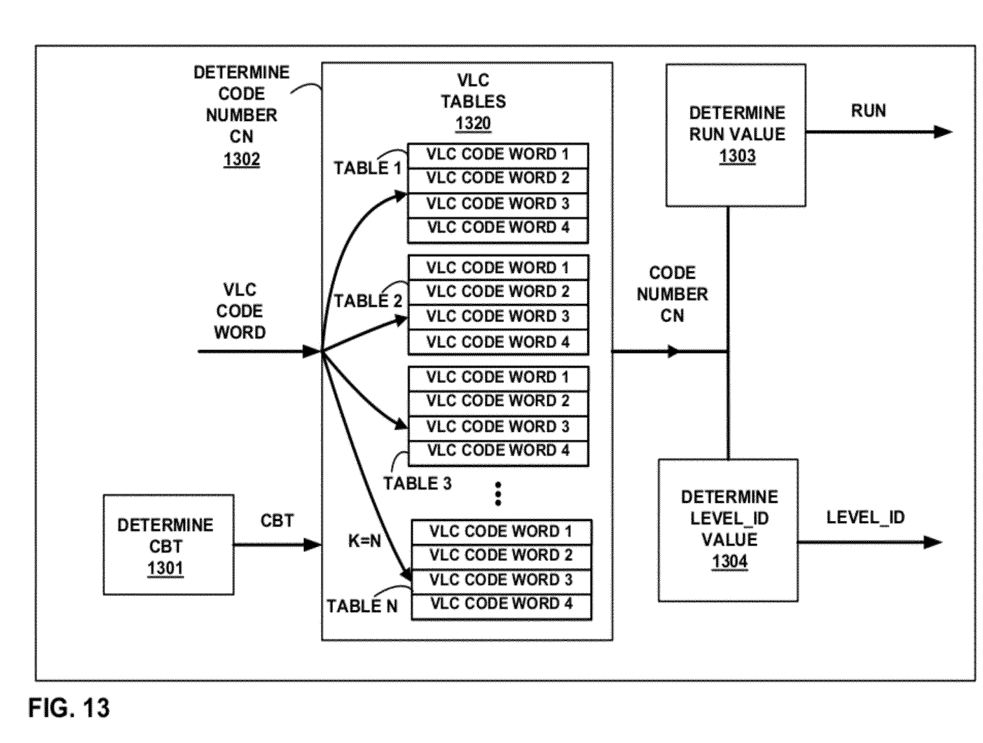

FIG. 13 is a conceptual diagram that illustrates one example of a technique that may be performed by a video decoder 350 to decode at least one transform coefficient of a block of video data, consistent with one or more aspects of this disclosure. The technique depicted in FIG. 13 is described as being performed by video decoder 350 depicted in FIG. 2, although other devices may also be used to perform the technique.

As depicted in the example of FIG. 13, video decoder 350 may determine a coded block type of a block of video data being decoded. For example, video decoder 350 may determine the coded block type of the block of video data based on one or more syntax elements signaled to video decoder 350 from an encoder (e.g., encoder 250 depicted in FIG. 2) that encoded the block of video data. In some examples, the coded block type of the block of video data may comprise an intra-luma, intra-chroma, inter-luma, or inter-chrome coded block type.

As also depicted in FIG. 13, video decoder 350 may map from a VLC code word to a code number cn, based on the determined coded block type of the block of video data being decoded (1302). The VLC codeword may represent run and level_ID syntax elements. In some examples, video decoder 350 may receive the VLC codeword by accessing a storage component such as a memory 345 associated with video decoder 350, or by accessing another form of storage medium. In other examples, video decoder 350 may receive the VLC codeword via a communications module (e.g., receiver 128 depicted in FIG. 1) of the decoder 350 (e.g., from another computing device).

In some examples, to determine the code number cn, video decoder 350 may select a VLC table of a plurality of VLC tables 1320, based on the determined coded block type of the block of video data being decoded. For example, as depicted in FIG. 13, video decoder 350 may have access to a plurality of VLC tables 1320, table 1-table N. The plurality of VLC tables 1320 depicted in FIG. 13 are provided for exemplary purposes only. In some examples, plurality of VLC tables 1320 may include more, or fewer, VLC tables than depicted in FIG. 13. Furthermore, according to the example of FIG. 13, each of VLC tables 1-N only includes four VLC codewords. In some examples, one or more of VLC tables 1-N 1320 may include more, or fewer, VLC codewords.

As described above, according to some aspects of this disclosure, video decoder 350 may select a VLC table of a plurality of VLC tables 1320 described above, based on a coded block type of a block of video data being decoded. For example, for a particular transform coefficient of the block of video data, video decoder 350 may select a first table (e.g., table 3 in the example of FIG. 13) of the plurality of VLC tables 1320 if the block of video data has a first coded block type. However, if the block of video data has a second coded block type, video decoder 350 may select a second, different VLC table (e.g., table 2 in the example of FIG. 13). In some examples, video decoder 350 may also select such a VLC table based on a position k of a current transform coefficient, as well as based on the coded block type of the block of video data being coded. In other examples, video decoder 350 may not use VLC tables 1320 to determine the code number cn. Instead, video decoder 350 may determine the code number cn based on a mathematical relationship that is based on the coded block type of the block of video data.

As also depicted in FIG. 13, video decoder 350 may determine a run syntax element associated with a transform coefficient of a block of video data based on the determined code number cn (1303). As also depicted in FIG. 13, video decoder 350 may determine a level_ID syntax element associated with the transform coefficient of a block of video data based on the determined code number cn (1304). In some examples, video decoder 350 may determine the run and level_ID syntax elements based on accessing a mapping table of a plurality of mapping tables stored in a memory associated with video decoder 350, e.g., using the code number cn as an index to the mapping table. According to other examples, video decoder 350 may determine the run and level_ID syntax elements based on a structured mapping between the run and level_ID syntax elements and the code number cn.

In some examples, video decoder 350 may use the determined run and level_ID syntax elements to decode the block of video data. For example, video decoder 350 may use the determined run syntax elements to determine a number of zero coefficients between a current coefficient, and a next non-zero coefficient of a scan (e.g., an inverse zig-zag scan). Video decoder 350 may use the level_ID syntax element to determine whether at least one coefficient of the block of video data has a value of one or greater than one. In some examples, determining a code number cn using a VLC codeword determined based on a VLC table selected based on a coded block type of a block of video data as described above may be advantageous, because these techniques may provide for improved coding efficiency and/or quality in comparison to other video coding techniques.

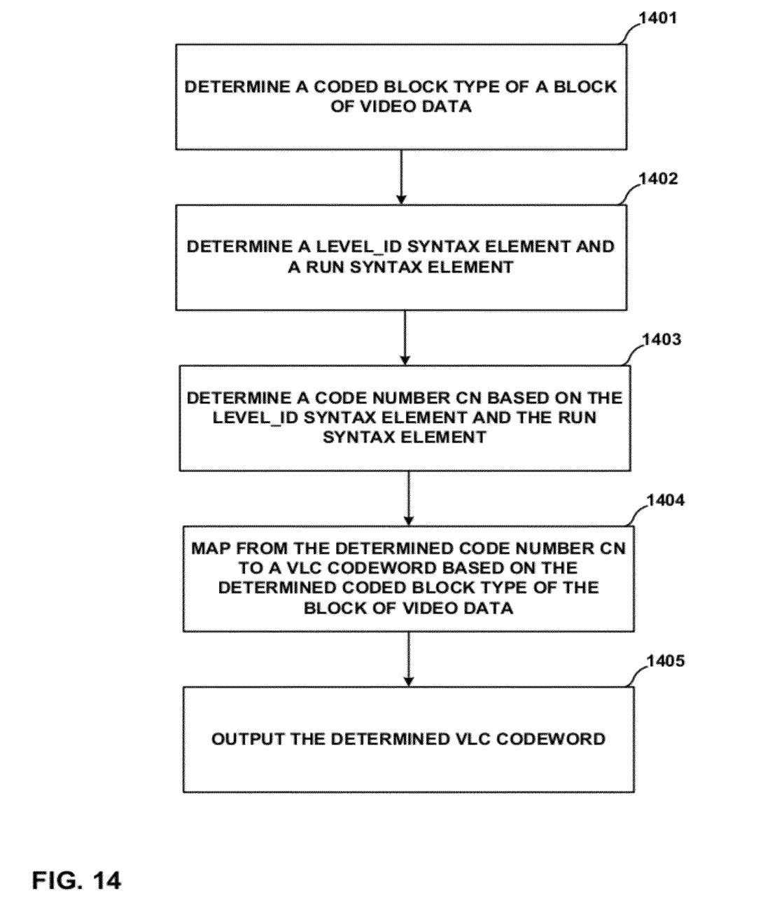

FIG. 14 is a flow diagram that illustrates one example of a method of encoding at least one transform coefficient of a block of video data according to one or more aspects of this disclosure. The method depicted in FIG. 14 is described as being performed by encoder 250 depicted in FIG. 2, however other devices may be used to perform the techniques of FIG. 14.

As depicted in FIG. 14, video encoder 250 may determine a coded block type of a block of video data (1401). The coded block type may comprise, for example an inter-luma, inter-chroma, intra-luma, or intra-chroma coded block type. As also depicted in FIG. 14, vide encoder 250 may determine a level_ID syntax element and a run syntax element associate with a transform coefficient of a block of video data (1402). The level_ID syntax element may indicate a magnitude of the transform coefficient. The run syntax element may indicate a number of zero value coefficients between a current coefficient and a next non-zero coefficient of a scan (e.g., an inverse zig-zag scan).

As also depicted in FIG. 14, video encoder 250 may determine a code number cn using the determined level_ID syntax element and the determined run syntax element (1403). For example, video encoder 250 may determine the code number cn using a selected mapping table of a plurality of mapping tables stored in a memory associated with video encoder 250. In other example, video encoder 250 may determine the code number cn using a structured mapping that defines a relationship between the code number cn and the level_ID and run syntax elements.

As also depicted in FIG. 14, video encoder 250 may map from the determined code number cn to a VLC codeword based on the determined coded block type of the block of video data being encoded by video encoder 250 (1404). For example, if the determined coded block type comprises a first coded block type, video encoder 250 may select a first VLC table of a plurality of VLC tables stored in a memory associated with video encoder 250 (e.g., memory 245 depicted in FIG. 2). However, if the determined coded block type comprises a second coded block type, video encoder 250 may select a second VLC table of the plurality of VLC table stored in the memory. According to other examples, video encoder 250 may use a mathematical relationship to determine the VLC codeword, based on the coded block type of the block of video data being encoded.

As also depicted in FIG. 14, video encoder 250 may output the determined VLC codeword. For example, the video encoder 250 may output the determined VLC codeword to a decoder 350. The decoder 350 may use the VLC codeword to decode the block of video data.

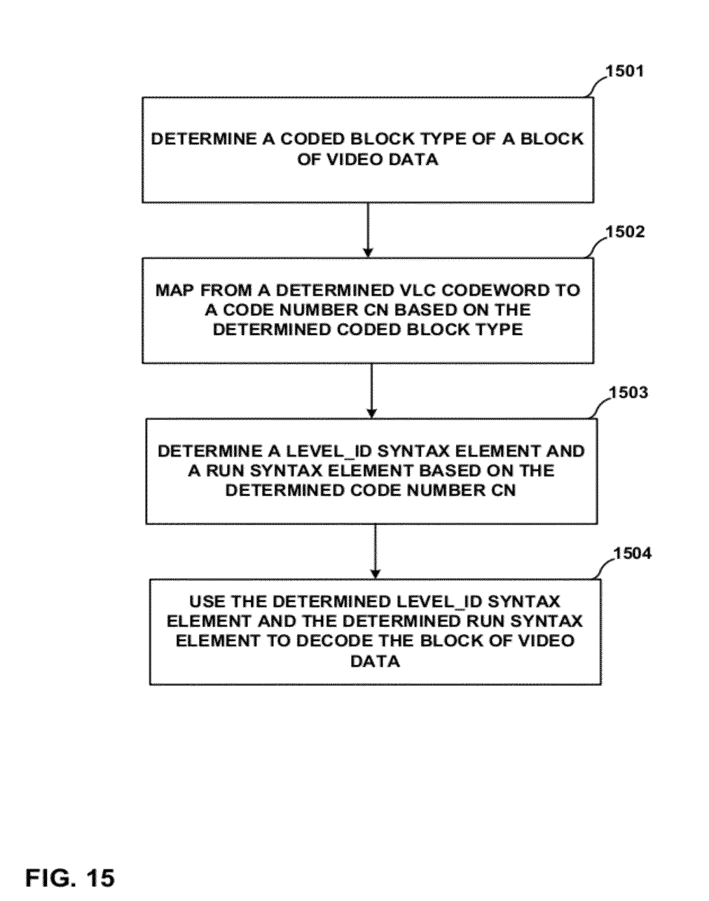

FIG. 15 is flow diagram that illustrates one example of a method of decoding at least one transform coefficient of a block of video data according to one or more aspects of this disclosure. The method depicted in FIG. 15 is described as being performed by encoder 350 depicted in FIG. 3, however other devices may be used to perform the techniques of FIG. 15.

As depicted in FIG. 15, video decoder 350 may determine a coded block type of a block of video data (1501). The coded block type may comprise, for example an inter-luma, inter-chroma, intra-luma, or intra-chroma coded block type.

As also depicted in FIG. 15, video decoder 350 may map from a VLC codeword to a code number cn based on the determined coded block type of the block of video data being decoded by video decoder 350 (1502). For example, if the determined coded block type comprises a first coded block type, video decoder 350 may select a first VLC table of a plurality of VLC tables stored in a memory associated with video decoder 350 (e.g., memory 245 depicted in FIG. 2). However, if the determined coded block type comprises a second coded block type, video decoder 250 may select a second VLC table of the plurality of VLC table stored in the memory. According to other examples, video decoder may map from the VLC codeword to the code number cn using a mathematical relationship based on the determined coded block type of the block of vide data being decoded.

As also depicted in FIG. 15 vide decoder 350 may determine a level_ID syntax element and a run syntax element associated with a transform coefficient of a block of video data using the determined code number cn (1503). The level_ID syntax element may indicate a magnitude of the transform coefficient. The run syntax element may indicate a number of zero value coefficients between a current coefficient and a next non-zero coefficient of a scan (e.g., an inverse zig-zag scan).

Video decoder 350 may determine level_ID and run syntax elements using a selected mapping table of a plurality of mapping tables stored in a memory associated with video decoder 350 (1504). In other examples, video decoder 350 may determine the level_ID and run syntax elements based on the determined code number cn using a structured mapping that defines a relationship between the code number cn and the level_ID and run syntax elements.

As also depicted in FIG. 15, video decoder 350 may use the determined level_ID and run syntax elements to decode a block of video data. For example, video decoder 350 may use the level_ID syntax element to determine whether at least one coefficient of the block of video data has a magnitude of one, or greater than one. As another example, video decoder 350 may use the run syntax element to determine a number of zero value coefficients between a current coefficient and a next non-zero coefficient of the block of video data.

In one or more examples, the functions described herein may be implemented at least partially in hardware, such as specific hardware components or a processor. More generally, the techniques may be implemented in hardware, processors, software, firmware, or any combination thereof. If implemented in software, the functions may be stored on or transmitted over as one or more instructions or code on a computer-readable medium and executed by a hardware-based processing unit. Computer-readable media may include computer-readable storage media, which corresponds to a tangible medium such as data storage media, or communication media including any medium that facilitates transfer of a computer program from one place to another, e.g., according to a communication protocol. In this manner, computer-readable media generally may correspond to (1) tangible computer-readable storage media which is non-transitory or (2) a communication medium such as a signal or carrier wave. Data storage media may be any available media that can be accessed by one or more computers or one or more processors to retrieve instructions, code and/or data structures for implementation of the techniques described in this disclosure. A computer program product may include a computer-readable medium.

By way of example, and not limitation, such computer-readable storage media can comprise RAM, ROM, EEPROM, CD-ROM or other optical disk storage, magnetic disk storage, or other magnetic storage devices, flash memory, or any other medium that can be used to store desired program code in the form of instructions or data structures and that can be accessed by a computer. Also, any connection is properly termed a computer-readable medium, i.e., a computer-readable transmission medium. For example, if instructions are transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. It should be understood, however, that computer-readable storage media and data storage media do not include connections, carrier waves, signals, or other transient media, but are instead directed to non-transient, tangible storage media. Disk and disc, as used herein, includes compact disc (CD), laser disc, optical disc, digital versatile disc (DVD), floppy disk and blu-ray disc where disks usually reproduce data magnetically, while discs reproduce data optically with lasers. Combinations of the above should also be included within the scope of computer-readable media.

Instructions may be executed by one or more processors, such as one or more central processing units (CPU), digital signal processors (DSPs), general purpose microprocessors, application specific integrated circuits (ASICs), field programmable logic arrays (FPGAs), or other equivalent integrated or discrete logic circuitry. Accordingly, the term “processor,” as used herein may refer to any of the foregoing structure or any other structure suitable for implementation of the techniques described herein. In addition, in some aspects, the functionality described herein may be provided within dedicated hardware and/or software modules configured for encoding and decoding, or incorporated in a combined codec. Also, the techniques could be fully implemented in one or more circuits or logic elements.

The techniques of this disclosure may be implemented in a wide variety of devices or apparatuses, including a wireless handset, an integrated circuit (IC) or a set of ICs (e.g., a chip set). Various components, modules, or units are described in this disclosure to emphasize functional aspects of devices configured to perform the disclosed techniques, but do not necessarily require realization by different hardware units. Rather, as described above, various units may be combined in a codec hardware unit or provided by a collection of interoperative hardware units, including one or more processors as described above, in conjunction with suitable software and/or firmware.

Various examples been described. These and other examples are within the scope of the following claims.

1-32. (canceled)

33. A method of coding a block of video data, comprising:
using a variable length code (VLC) table index value to map between a first code number cn and a first VLC codeword associated with at least a first block of video data;
updating the VLC table index value based on a scaling factor M; and using the updated VLC table index value to map between a second code number cn and a second VLC codeword associated with a second block of video data.

34. The method of claim 33, wherein using the updated VLC table index value to map between the second code number cn and the second VLC codeword associated with the second block of video data comprises using the updated VLC table index value to access an array of VLC table numbers to determine a VLC table number; and
using the determined VLC table number to identify a VLC table of a plurality of VLC tables.

35. The method of claim 34, further comprising:
using the identified VLC table of the plurality of VLC tables to map between the second code number cn and the second VLC codeword.

36. The method of claim 33, wherein the method comprises a method of decoding the block of video data, and further comprising:
determining the first code number cn based on the first VLC codeword that represents a last_pos syntax element and a level_ID syntax element associated with a first block of video data;
updating the VLC table index value based on the determined first code number cn and the scaling factor M; and
determining the last_pos syntax element and the level_ID syntax element associated with the first block of video data based on the determined first code number cn;
using the determined last_pos syntax element and the determined level_ID syntax element associated with the first block of video data to decode the first block of video data;
determining, using the updated VLC table index value, the second code number cn based on the second VLC codeword that represents the last_pos syntax element and the level_ID syntax element associated with a second block of video data;
determining the last_pos syntax element and the level_ID syntax element associated with the second block of video data based on the determined second code number cn; and
using the determined last_pos syntax element and the determined level_ID syntax element associated with the second block of video data to decode the second block of video data.

37. The method of claim 33, wherein the last_pos syntax element indicates a first non-zero coefficient of the block of video data according to a inverse scan order of the block of video data; and
wherein the level_ID syntax element indicates a magnitude of the first non-zero coefficient of the block of video data according to the inverse scan order of the block of video data.

38. The method of claim 33, wherein the method comprises a method of encoding a block of video data, and further comprising:
determining a last_pos syntax element and a level_ID syntax element associated with a first block of video data;
using the determined level_ID syntax element and the determined last_pos syntax element associated with the first block of video data to determine the first code number cn;
using the determined first code number cn and the VLC table index value to determine the first VLC codeword;
updating the VLC table index value based on the determined first code number cn and the scaling factor M; and
outputting the first VLC codeword;
determining the last_pos syntax element and the level_ID syntax element associated with a second block of video data;
determining the second code number cn based on the determined last_pos syntax element and the determined level_ID syntax element associated with the second block of video data;
using the determined second code number cn and the updated VLC table index value to determine the second VLC codeword; and
outputting the determined second VLC codeword.

39. The method of claim 38, wherein the last_pos syntax element indicates a first non-zero coefficient of the block of video data according to a reverse scan order of the block of video data; and
wherein the level_ID syntax element indicates a magnitude of the first non-zero coefficient of the block of video data according to the reverse scan order of the block of video data.

40. The method of claim 33, wherein using the updated VLC table index value to map between a second code number cn and a second VLC codeword comprises:
using the updated VLC table index value to select a VLC table of a plurality of VLC tables stored in memory based on the updated VLC table index value.

41. The method of claim 33, wherein the scaling factor M is defined based on a size of the first block of video data.

42. A device configured to code at least one block of video data, comprising:
a variable length code (VLC) coding module configured to:
use a VLC table index value to map between a first code number cn and a first VLC codeword;
update the VLC table index value based on a scaling factor M; and
use the updated VLC table index value to map between a second code number cn and a second VLC codeword.

43. The device of claim 42, wherein the VLC coding module is configured to use the updated VLC table index value to access an array of VLC table numbers to determine a VLC table number; and
use the determined VLC table number to identify a VLC table of a plurality of VLC tables.

44. The device of claim 43, wherein the VLC coding module is configured to use the identified VLC table of the plurality of VLC tables to map between the second code number cn and the second VLC codeword.

45. The device of claim 42, wherein VLC coding module comprises a VLC decoding module, and wherein the VLC decoding module is configured to:
determine the first code number cn based on the first VLC codeword that represents a last pos syntax element and a level_ID syntax element associated with a first block of video data;
update the VLC table index value based on the determined first code number cn and the scaling factor M; and
determine the last_pos syntax element and the level_ID syntax element associated with the first block of video data based on the determined first code number cn;
use the determined last_pos syntax element and the determined level_ID syntax element associated with the first block of video data to decode the first block of video data;
determine, using the updated VLC table index value, the second code number cn based on the second VLC codeword that represents the last_pos syntax element and the level_ID syntax element associated with a second block of video data;
determine the last_pos syntax element and the level_ID syntax element associated with the second block of video data based on the determined second code number cn; and
use the determined last_pos syntax element and the determined level_ID syntax element associated with the second block of video data to decode the second block of video data.

46. The device of claim 45, wherein the last_pos syntax element indicates a first non-zero coefficient of the block of video data according to a inverse scan order of the block of video data; and
wherein the level_ID syntax element indicates a magnitude of the first non-zero coefficient of the block of video data according to the inverse scan order of the block of video data.

47. The device of claim 42, wherein the VLC coding module comprises a VLC encoding module configured to:
determine a last_pos syntax element and a level_ID syntax element associated with a first block of video data;
use the determined level_ID syntax element and the determined last_pos syntax element associated with the first block of video data to determine the first code number cn;
use the determined first code number cn and the VLC table index value to determine the first VLC codeword;
update the VLC table index value based on the determined first code number cn and the scaling factor M; and
output the first VLC codeword;
determine the last_pos syntax element and the level_ID syntax element associated with a second block of video data;
determine the second code number cn based on the determined last_pos syntax element and the determined level_ID syntax element associated with the second block of video data;
use the determined second code number cn and the updated VLC table index value to determine the second VLC codeword; and
output the determined second VLC codeword.

48. The device of claim 47, wherein the last_pos syntax element indicates a first non-zero coefficient of the block of video data according to a reverse scan order of the block of video data; and
wherein the level_ID syntax element indicates a magnitude of the first non-zero coefficient of the block of video data according to the reverse scan order of the block of video data.

49. The device of claim 42, wherein the VLC coding module is configured to:
use the updated VLC table index value to select a VLC table of a plurality of VLC tables stored in memory based on the updated VLC table index value.

50. The device of claim 42, wherein the scaling factor M is defined based on a size of the first block of video data.

51. A computer-readable storage medium that stores instructions that, when executed, cause a computing device to:
use a variable length code (VLC) table index value to map between a first code number cn and a first VLC codeword;
update the VLC table index value based on a scaling factor M; and
use the updated VLC table index value to map between a second code number cn and a second VLC codeword.

52. The computer-readable storage medium of claim 51, wherein the instructions cause the computing device to use the updated VLC table index value to access an array of VLC table numbers to determine a VLC table number; and
use the determined VLC table number to identify a VLC table of a plurality of VLC tables.

53. The computer-readable storage medium of claim 52, wherein the instructions cause the computing device to use the identified VLC table of the plurality of VLC tables to map between the second code number cn and the second VLC codeword.

54. The computer-readable storage medium of claim 51, wherein the instructions cause the computing device to:
determine the first code number cn based on the first VLC codeword that represents a last pos syntax element and a level_ID syntax element associated with a first block of video data;
update the VLC table index value based on the determined first code number cn and the scaling factor M; and
determine the last_pos syntax element and the level_ID syntax element associated with the first block of video data based on the determined first code number cn;
use the determined last_pos syntax element and the determined level_ID syntax element associated with the first block of video data to decode the first block of video data;
determine, using the updated VLC table index value, the second code number cn based on the second VLC codeword that represents the last_pos syntax element and the level_ID syntax element associated with a second block of video data;
determine the last_pos syntax element and the level_ID syntax element associated with the second block of video data based on the determined second code number cn; and
use the determined last_pos syntax element and the determined level_ID syntax element associated with the second block of video data to decode the second block of video data.

55. The computer-readable storage medium of claim 54, wherein the last_pos syntax element indicates a first non-zero coefficient of the block of video data according to a inverse scan order of the block of video data; and
wherein the level_ID syntax element indicates a magnitude of the first non-zero coefficient of the block of video data according to the inverse scan order of the block of video data.

56. The computer-readable storage medium of claim 51, wherein the instructions cause the computing device to:
determine a last_pos syntax element and a level_ID syntax element associated with a first block of video data;
use the determined level_ID syntax element and the determined last_pos syntax element associated with the first block of video data to determine the first code number cn;
use the determined first code number cn and the VLC table index value to determine the first VLC codeword;
update the VLC table index value based on the determined first code number cn and the scaling factor M; and
output the first VLC codeword;
determine the last_pos syntax element and the level_ID syntax element associated with a second block of video data;
determine the second code number cn based on the determined last_pos syntax element and the determined level_ID syntax element associated with the second block of video data;
use the determined second code number cn and the updated VLC table index value to determine the second VLC codeword; and
output the determined second VLC codeword.

57. The computer-readable storage medium of claim 56, wherein the last_pos syntax element indicates a first non-zero coefficient of the block of video data according to a reverse scan order of the block of video data; and
wherein the level_ID syntax element indicates a magnitude of the first non-zero coefficient of the block of video data according to the reverse scan order of the block of video data.

58. The computer-readable storage medium of claim 51, wherein the instructions cause the computing device:
use the updated VLC table index value to select a VLC table of a plurality of VLC tables stored in memory based on the updated VLC table index value.

59. The computer-readable storage medium of claim 51, wherein the instructions cause the computing device to define the scaling factor M based on a size of the first block of video data.

60. A device configured to code at least one block of video data, comprising:
means for using a variable length code (VLC) table index value to map between a first code number cn and a first VLC codeword;
means for updating the VLC table index value based on a scaling factor M; and
means for using the updated VLC table index value to map between a second code number cn and a second VLC codeword.

61. The device of claim 60, further comprising:
means for using the updated VLC table index value to map between the second code number cn and the second VLC codeword associated with the second block of video data comprises using the updated VLC table index value to access an array of VLC table numbers to determine a VLC table number; and
means for using the determined VLC table number to identify a VLC table of a plurality of VLC tables.

62. The device of claim 61, further comprising:
using the identified VLC table of the plurality of VLC tables to map between the second code number cn and the second VLC codeword.

63. The device of claim 60, further comprising:
means for determining the first code number cn based on the first VLC codeword that represents a last_pos syntax element and a level_ID syntax element associated with a first block of video data;
means for updating the VLC table index value based on the determined first code number cn and the scaling factor M; and
means for determining the last_pos syntax element and the level_ID syntax element associated with the first block of video data based on the determined first code number cn;
means for using the determined last_pos syntax element and the determined level_ID syntax element associated with the first block of video data to decode the first block of video data;
means for determining, using the updated VLC table index value, the second code number cn based on the second VLC codeword that represents the last_pos syntax element and the level_ID syntax element associated with a second block of video data;
means for determining the last_pos syntax element and the level_ID syntax element associated with the second block of video data based on the determined second code number cn; and
means for using the determined last_pos syntax element and the determined level_ID syntax element associated with the second block of video data to decode the second block of video data.

64. The device of claim 63, wherein the last_pos syntax element indicates a first non-zero coefficient of the block of video data according to a inverse scan order of the block of video data; and
wherein the level_ID syntax element indicates a magnitude of the first non-zero coefficient of the block of video data according to the inverse scan order of the block of video data.

65. The device of claim 60, further comprising:
means for determining a last_pos syntax element and a level_ID syntax element associated with a first block of video data;
means for using the determined level_ID syntax element and the determined last_pos syntax element associated with the first block of video data to determine the first code number cn;
means for using the determined first code number cn and the VLC table index value to determine the first VLC codeword;
means for updating the VLC table index value based on the determined first code number cn and the scaling factor M; and
means for outputting the first VLC codeword;
means for determining the last_pos syntax element and the level_ID syntax element associated with a second block of video data;
means for determining the second code number cn based on the determined last_pos syntax element and the determined level_ID syntax element associated with the second block of video data;
means for using the determined second code number cn and the updated VLC table index value to determine the second VLC codeword; and
means for outputting the determined second VLC codeword.

66. The device of claim 65, wherein the last_pos syntax element indicates a first non-zero coefficient of the block of video data according to a reverse scan order of the block of video data; and
wherein the level_ID syntax element indicates a magnitude of the first non-zero coefficient of the block of video data according to the reverse scan order of the block of video data.

67. The device of claim 60, further comprising:
means for using the updated VLC table index value to select a VLC table of a plurality of VLC tables stored in memory based on the updated VLC table index value.

68. The device of claim 60, wherein the scaling factor M is defined based on a size of the first block of video data.

69-110. (canceled)
